(19) United States
(12) Patent Application Publication
(10) Pub. No.: US 2003/0005152 A1
(43) Pub. Date: Jan. 2, 2003

(54) Content-request redirection method and system

(76) Inventors: Arif Diwan, Cranston, RI (US); Lois F. Welber, Boston, MA (US); Richard M. Koolish, Arlington, MA (US); Frank Bronzo, Watertown, MA (US); Douglas C. Gilbert, Shrewsbury, MA (US)

Correspondence Address: Leonard Charles Suchyta, c/o Christian Andersen, Verizon Services Group, 600 Hidden Ridge, HQE03H01, Irving, TX, 75038, US

(21) Appl. No.: 10/094,133

(22) Filed: Mar. 11, 2002

Related U.S. Application Data
(60) Provisional application No. 60/275,194, filed on Mar. 9, 2001.
(60) Provisional application No. 60/362,339, filed on Mar. 8, 2002.
(60) Provisional application No. 60/362,553, filed on Mar. 8, 2002.

(51) Int. Cl. G06F 15/173; G06F 15/16

(52) U.S. Cl. 709/239; 709/219

(57) ABSTRACT

Requests for content such as large multimedia files are redirected to avoid congestion and delivery delays on network backbones. In embodiments, user requests for content are redirected from the content provider's site to a network node proximate to the user. The content is served to the user without using the backbone of the Internet. In embodiments, content items are distributed to edge nodes proximate to users by satellite or other system substantially separate from the Internet. The engines for receiving and redirecting user access requests for content may be updated in near real time with information such as content disposition, node operational status and user addresses and profiles.

### RELATED APPLICATIONS

This application claims priority to U.S. provisional application Serial No. 60/275,194, filed Mar. 9, 2001 the entirety of which is incorporated into this specification by reference, and to U.S. provisional application Serial No. ______, filed Mar. 8, 2002 (Docket No. 01-4024PRO2), the entirety of which is incorporated into this specification by reference, and to U.S. provisional application Serial No. ______, filed Mar. 8, 2002 (Docket No. 01-4024PRO3), the entirety of which is incorporated by reference.

### FIELD OF THE INVENTION

The present invention relates generally to the delivery of content using a telecommunications network such as the Internet. More particularly, the present invention relates to a method of serving content to a user that avoids the backbone and otherwise reduces congestion and delays in a telecommunications network, such as the Internet.

### BACKGROUND OF THE INVENTION

Increasingly, content such as audio, images (moving and still) and multimedia presentations are being delivered electronically over the Internet. Users typically expect that high-quality audio and moving and still images will be delivered on demand, with the expected quality, and without interruption, delay or distortion. Meeting this expectation often requires the ability to send, receive and display content in real time so that users can experience the content as it was intended to be experienced, by the original producer. Content providers have thus developed systems and techniques to stream audio, video and multimedia content from their servers to their customers and other users in real time.

Demand for Internet transmission capacity is expected to continue to grow. There are at least two reasons for this growth. First, the number of Internet users demanding streamed or real-time content is expected to increase. Second, the number of individuals and enterprises interested in producing and distributing content, and in particular high-quality audio and video content, is expected to increase, thereby increasing the amount of content available for streaming.

If Internet transmission capacity is not sufficient to handle the demand for streaming, congestion will result, producing transmission delays and errors, which in turn will degrade the quality or timeliness, or both, of the content transmitted and presented to users. On the other hand, it can be costly and time-consuming to increase Internet capacity, including backbone resources such as transmission facilities (e.g., fiber optic cables), switches and routers, to meet expected or experienced increases in demand for transmission capacity.

Accordingly, there is a need to develop methods and systems for delivering content to a user connected to a network such as the Internet in a manner that avoids or at least reduces the potential for congestion on the backbone of that network. More specifically, there is a need to develop methods and systems for delivering content to users connected to a network, such as the Internet, without necessarily requiring use of the backbone or infrastructure of that network for each item of content requested by and delivered to users connected to that network.

### FEATURES OF THE INVENTION

The following features are present in some, but not necessarily all, embodiments of the present invention.

It is a feature of an embodiment of the present invention to redirect a request for a content item by a user from the content provider's server to a server proximate to the user for serving the requested content item to the user.

It is a feature of an embodiment of the invention to construct and update tables or other structures automatically, and optionally in near real time, for determining the server or service to which a user requesting a content item is to be redirected.

It is a feature of an embodiment of the invention to ensure that a user is redirected to servers that are available to respond to the user's request for a content item.

It is a feature of an embodiment of the invention to track content server operational status in near real time and to redirect user requests for content in response to server operational status information.

It is a feature of an embodiment of the invention to track content server load in near real time and to redirect user requests for content in response to server load information.

It is a feature of an embodiment of the invention to provide the ability to redirect or block a user or certain classes of users from certain items, categories or classes of content items depending on demographics, geography, and other attributes.

It is a feature of an embodiment of the invention to provide the ability to serve different content items to different sets of users based on their location or demographic or other characteristics.

These and other features and advantages of the present invention are apparent in view of this specification and will become apparent upon practice of the present invention. For example, while the Internet is used to illustrate the present invention, it is apparent that the present invention can be utilized and practiced in the context of other networks as well.

### SUMMARY OF THE INVENTION

The invention provides a system and method for accelerated delivery of content items to a user of the Internet or other telecommunications network. In an embodiment, a method of the invention entails receiving a user access request from a user and redirecting the user to a service point, such that the requested content is served to the user from the service point. In an embodiment, the user access request specifies a content item from a plurality of content items and a user address from a plurality of user addresses, and the service point is selected responsive to the specified content item and user address. In an embodiment, a system of the invention uses a user address database, which relates user addresses to specific service points, and a content item database, which relates service points to content items. The user requesting content from a content provider is redirected to a service point associated with the user, which has the content item requested by the user, and from which the requested content item may be served to the user.

According to embodiments of the present invention, delays in serving content items over the Internet to users are significantly reduced, if not eliminated, by broadcasting content items to servers located at the edges of the Internet via satellite or other point-to-multipoint systems that do not substantially use the Internet. In such embodiments, the content item, which can include a substantial amount of information whose real-time transmission requires a substantial amount of transmission capacity, is not transmitted over the backbone of the Internet. In embodiments, each content item is distributed without using the backbone to a server or service at one or more network nodes, known as edges (e.g., Internet ISP nodes) proximate to users. A requested content item is not transmitted over the Internet backbone from the content provider to the user; rather, the user is sent a much smaller amount of information that directs the user to an edge node proximate to the particular user from which the requested content item will be served, again without using the backbone or infrastructure of the Internet. Accordingly, preferred strategies for distributing content items to nodes include the distribution of large numbers of content items to each edge—that is, to each node proximate to sets of users making requests for content items—before users actually make requests for those content items. Content items are thus advantageously positioned in advance to enable rapid and efficient responses to user requests for content.

In embodiments, a content-request redirection system of the present invention receives near real-time information on the disposition of content items at servers and services and receives near real-time information on the operational status and load of servers and other components and services at the edges. This information can include, for example, how many content streams the server can transmit, the delivery rate of each stream, and an amount of headroom assigned to the server in order to avoid overloads. Thus, in embodiments, selection of the location, server or service for serving content items in response to a user request may be based on one or a combination of factors, including the proximity of the server and the user, the availability and load of the server, the availability of the content item, and the cost of transmitting the content item from a server to the user. The distribution of content to edges, coupled with near real-time information on content item disposition, server status and load information and routing and transmission, enable embodiments of systems of the present invention to make intelligent and rapid decisions to redirect users to servers that can effectively and efficiently serve content items requested by the users, as if the user were being served the content item directly (e.g., via the Internet backbone) from the content provider's website.

In embodiments, the Internet Protocol (IP) address of the user in a request for a content item (for example an HTTP request) is associated, for example in a source block table, with a node or location, which is included in a user address database and is used in redirecting a user to a node, service point, server or service in response to a request for content. In embodiments, the edge associated with the user IP address is the first choice for serving the requested content item.

In embodiments of the present invention, service points or nodes may be arranged hierarchically in layers, such as a highest layer, one or more intermediate layers, and a lowest layer. In such an arrangement, nodes or service points could be classified so that edge nodes—i.e., nodes most proximate to users and therefore preferred in many embodiments for serving content to users—would be included in the lowest layer. Nodes or service points used to provide backup or failover protection for one or more edge nodes would be classified as regional nodes in an intermediate layer, and one or more nodes used to provide backup or failover for one or more regional nodes would be classified as center nodes in the highest layer.

According to embodiments of the present invention, redirection is achieved in response to a user's request for a content item by sending the user the URL or other address where the content item is located and available for transmission in response to the request. In other embodiments, redirection is achieved by sending the user a container or file including the URL or other address of each content item responsive to the user's request. For example, a container may include both the URL of the requested content item and a URL of a specialized media player needed in order to play the content. In some embodiments of the invention, the URLs in a container are predetermined or “hard coded.” In other embodiments, a container may include a macro or other program that computes or determines the needed URL—including, in embodiments, in near real time in response to each specific user access request for content items—based on available information, including the locations and disposition of the content item, server load, and user preferences.

The present invention also provides a processor comprising program logic configuring the processor to (i) receive, via a first network, a user access request generated by a user specifying a content item of a plurality of content items and a user address, associated with the user, of a plurality of user addresses, and (ii) determine, responsive to the content item and the user address, a service point of a plurality of service points. The processor communicates with a user address database that relates the plurality of user addresses to the plurality of service points, and a content item database that relates the plurality of service points to the plurality of content items. Each of the plurality of content items is distributed, prior to receipt by the processor of the user access request, to at least one of the plurality of service points using a second network substantially separate from the first network. In embodiments of the present invention, the processor or other components (including for example other processors, servers, services, hardware, software or combinations thereof) comprise program logic or instructions to configure (or otherwise enable) the processor or component to perform the functions, steps and activities described in this specification and the appended claims for the present invention.

The present invention further provides a transmitter for transmitting a plurality of signals to a processor using a first network, where the signals encode a user access request comprising a specification of a content item of a plurality of content items and a user address, associated with a user, of a plurality of user addresses. Program logic configures the processor to receive the user access request and determine, responsive to the content item and the user address, a service point of a plurality of service points. A user address database relates the plurality of user addresses to the plurality of service points, and a content item database relates the plurality of service points to the plurality of content items. Each of the plurality of content items is distributed, prior to receipt by the processor of the user access request, to at least one of the plurality of service points using a second network substantially separate from the first network. In some embodiments, the processor or other components (including for example other processors, servers, services, hardware, software or combinations thereof) comprise program logic or instructions to configure the processor or component to perform the functions, steps and activities described in this specification and the appended claims for systems and methods of the present invention.

The present invention also provides a system for redirecting computer network users comprising (i) means for receiving a user access request from a user, wherein the user access request specifies a content item of a plurality of content items and a user address of a plurality of user addresses and (ii) means for redirecting the user, using a first network, to a service point of a plurality of service points, responsive to the content item and the user address. A user address database relates the plurality of user addresses to the plurality of service points, and a content item database relates the plurality of service points to the plurality of content items. Each of the plurality of content items is distributed, prior to receipt of the user access request, to at least one of the plurality of service points using a second network substantially separate from the first network. The structures corresponding to the receiving means and the redirecting means include processors, servers, transmitters, receivers, computers, servers or other components, as apparent in view of this specification and the appended claims.

### Definitions

As used in this specification, except to the extent that the context indicates otherwise, the following terms may be understood with reference to the definitions provided below. These definitions are exemplary and are used to illustrate the present invention, and should not be used to limit the scope of the invention or of any claim that uses a defined term, unless the meaning of the claim cannot otherwise be determined.

“Address block” refers to a range of IP addresses associated with a specific edge node.

“Backbone” refers to the infrastructure, including transmission and switching facilities of a network (including without limitation the Internet) or a portion of a network.

“Border Gateway Protocol” or “BGP” refers to a routing protocol which is an Internet standard routing protocol for exchanging routing information between ISPs, or any other protocol or application serving similar functions. In embodiments, a SPA or another piece of software in an edge node (service point) peers with an ISP's BGP speaker (typically a router) to collect BGP information and transform it into source block tables that are transmitted to a BRAM. The information communicated using BGP may be formatted as described in the BGP protocol definition as known in the art.

“BRAM” means BCC Remote Agent Manager, where “BCC” means Broadcast Control Center, as discussed in detail in this specification.

“Capacity” refers to the amount of work or load that can be performed by a server.

“Center Node” refers to a set of service points that together comprise a fallback service point for a user for which an edge node or a regional node is determined not to be available to serve a content item in response to a user access request. In embodiments, a center node may also be used to serve out-of-footprint users. A center node may be an ISP point of presence (POP) that has rich co-located peering with other ISPs, and is usually located on a high-speed backbone (OC48 or OC192), and may be a Tier 1 ISP facility. In embodiments, a center node may be coincident with a regional node, and there may be multiple physical center nodes in a redirection system embodying the present invention.

“Central messaging and control mechanism” refers to an application that manages messages that go into and out of a redirection system of the present invention. In embodiments, a BRAM serves as a central messaging and control mechanism.

“Container” or “container file” refers to a file that includes references to one or more content items, applications or other container files. In an embodiment, a user access request includes an HTTP GET instruction for an identified content item, and a corresponding HTTP REPLY to the user may include or refer to a container file. In an embodiment, a container file may be an ASCII file that contains either a list of URLs referring to content items (such as media files) or maybe an XML document that has information regarding what media files are played and when, along with encoding rules and other information required to stream different media files in varying order, possibly conditionally. In an embodiment, the URLs include hard coded URLs as well as macros, which may be rewritten by a redirection system of the present invention to reflect the URL of the server determined by an IRE, for example, for serving the requested content item(s) to the user. In an embodiment, standard media types such as RAM, ASX, and SMIL are supported.

“Content availability” refers to the availability of a content item within a redirection system of the present invention.

“Content aware redirection” is a feature of an embodiment of the invention that takes into account the location of content items on servers or services within a specific domain. In embodiments, users are only redirected to servers where content items are available with a given quality of service; in other embodiments, users are assigned attributes that specify that another quality of service will be used if an initial quality of service is not available. In an embodiment, content aware redirection takes into account the location of every content item on every server or service in every service point (node) within a specific domain.

“Content file” refers to a file that is positioned on a server at a node and can be served to a user via a service on the server. A content file is typically a multimedia data file encoding one or more content items such as an audio or video clip.

“Content item” refers to an embodiment of content or other information, such as an audio or video clip, that may be requested by a user. A content item is typically encoded in a content file.

“Content item database” refers to a data structure used in associating a content item to one or more applications or services residing on one or more servers. In embodiments, a content item map may reside in a commercial database or an application data structure.

“Content server” refers to a server that serves content items to a user.

“Content stream delivery rate” refers to the rate (e.g., megabits per second) at which a stream is served or delivered to a user.

“Content stream quantity” refers to the number of streams served by a server or that a server is capable of serving.

“CPU load” refers to a measure of the load on a central processing unit of a computer, and may be expressed as the amount of CPU time being used by applications and the operating system of a server or computer per unit of time.

“Edge node,” or “edge” refers to a group of one or more servers at a location that is associated with a set of user IP addresses. In preferred embodiments, an edge node refers to the service point which is the most proximate to the user, where proximity may be measured as described below. In embodiments, these associations, as well as a hierarchical arrangement between edge, regional, and center nodes, permit control over the strategy for determining which server should serve a content item in response to a user access request. In embodiments, a server or user is associated with only one edge node. Individual edge nodes may have individual properties that help direct the determination of the server that is to serve a content item in response to a user access request.

“Headroom” refers to the difference between the total capacity of a server and the maximum target server load of that server. A server is assigned headroom so that its total capacity is hardly if ever exceeded in practice, so that users receiving content items from the server hardly if ever experience delays or other degradations due to overloading of the server. In embodiments, the amount of headroom for a server may be changed or reconfigured for a variety of reasons, including experience with actual loads on the server, changes in the number or size of content items on the server, the number of users served by the server, and the like.

“Layer” refers to a level in a hierarchy that defines relationships between a set of nodes. In an embodiment with three layers, the highest layer includes one or more center nodes, the lowest layer includes one or more edges or edge nodes and the intermediate layer includes one or more regional nodes.

“Memory usage” refers to the amount of memory or the percent of total memory of a server or computer being used by the operating system and all the applications.

“Metric” refers to a unit or means of measure or assessment used to qualify the performance of a network or a network component. For example, a metric may be, but is not limited to, transmission time, transmission errors, CPU load, available bandwidth and server load.

“MIME Type” refers to a designator appended to a file name that instructs a browser or computer as to the type of content of the file.

“Node” is used interchangeably with “service point,” described below.

“Proximity” refers to a metric used to identify the best service point for serving content to a user. In embodiments, a proximate location is a location, including for example a server or service, that serves content items to a user with greater likelihood of high throughput of content delivery than other locations. In embodiments, a proximate server is a server coincident or very close (one or two router hops, for example) to a user's first point of access into the infrastructure of the user's ISP. In other embodiments, a proximate service point to a user may not be the closest service point (measured in router hops, distance, or another metric) to the user. In other embodiments, proximity may be determined based on transmission costs, switching costs, storage requirements, transmission speed or quality or other factors. In embodiments, a proximate point to a user is usually an edge node or a regional node that is also an edge node.

“Redirecting,” as in the phrase “redirecting a user,” refers to the function of referring a user who requested one or more content items from a content provider to a server at another location.

“Redirection system” refers to a system embodying the present invention for receiving a user access request and redirecting the user to a service point, other than the content provider's server, for serving a requested content item to the user.

“Regional node” refers to a set of service points that together comprise a fallback service point for a user for which an edge node is determined to be unsatisfactory according to a certain metric for serving to a content item in response to a user access request. Thus, a regional node can act as a fallback for an ISP's edge nodes, and in embodiments is connected to edge nodes via high-speed links (OC12, OC48, etc.), and is typically a Tier 1 or Tier 1 facility. In an embodiment, a regional node is an ISP POP with rich peering points with other POPs belonging to the same ISP. A regional node may also be an edge node, that is, a regional node may be the first access point into the ISP infrastructure for some users.

“Server” refers to a physical computing machine or system that serves content to one or more users. In embodiments, a server represents a specific Internet protocol (“IP”) address at which various services can be found.

“Server load” refers to the amount of work being performed by a particular server at a particular point in time. The amount of work may be measured by a metric. In an embodiment, this metric is computed as the cross product of the number of streams and the rate at which they are being served, i.e., [(content stream deliver rate 1 * number of streams at content stream deliver rate 1 )+(content stream delivery rate 2 * (number of streams at content stream deliver rate 2 )+ . . . ]. In an embodiment, server load has three values: (i) lightly loaded, (ii) heavily loaded, (iii) unavailable. Other metrics for computing server load may also be used with various embodiments of the present invention.

“Server status” refers to one or more conditions of a server. In embodiments, server status is reported by a smart probe on the server to a smart proxy agent. In an embodiment, “server status” may be “up” (i.e., operational but not available to serve content items due to software or other problems), “down,” or “available” (i.e., operational and available to serve content items).

“Service” refers to an application that directs the delivery of a content item (either dynamically generated or from a static source) from a server to a user. A redirection determination by a system embodying the present invention may redirect the user to a server or a service, and in that context “service” and “server” may be used interchangeably.

“Service point” or “node” refers to a location in a communications network, from which content items may be served. A service point or node contains one or more servers that serve one or more content items. In embodiments, a service point or node may contain other hardware and software that assists in serving content item, is associated with serving content item or providing network services and infrastructure, is used in managing or monitoring the service point, or serves other functions. Such other hardware and software may include switches (including smart switches), one or more smart proxy agents, one or more smart probes, and one or more routers. In embodiments, service points or nodes are arranged in layers.

“Site-scoped multicast message” refers to a protocol that defines ranges of addresses that refer to a group of destinations for a message. In embodiments, a site-scoped multicast message is restricted to a specific site and thus will not traverse the borders of the site. In embodiments, an administrative site-scoped multicast message is restricted to a specific administrative domain.

“Smart probe” refers to an application that resides on a server and monitors the status and health of the server or of applications (including services) running on the server or both.

“Smart proxy agent” (“SPA”) refers to an application that resides at a service point, and that acts as a proxy for that service point. In embodiments, an SPA may manage and maintain the service point, monitor the status and health of applications and devices (including servers) at the service point, either directly or by communicating with smart probes. In embodiments, an SPA may perform data reduction on information transmitted from the service point and may serve other functions.

“Source block” refers to a mapping of a group of addresses to a node. In embodiments of the present invention, source blocks form the basis for proximity determinations.

“Source block table” refers to a set of source blocks.

“Special service code” refers to a code that may be part of a user access request that enables an embodiment of a redirection system of the present invention to distinguish between user classes.

“Tailored content redirection” (“TCR”) is redirection where one or more content items served in response to a user's request are selected or tailored for a specific set of users, based on their location, user profile information or other information associated with those sets of users.

“Type of content” refers to a convention for classifying the content of a content file. In embodiments, the type of content is defined by the file-name extension of a content file, the IP address of the server serving the file, and the name of the port from which the content item is served. These inputs can be used to determine the MIME type of the content item, which is transmitted to and used by the user in displaying, playing or otherwise executing the content item.

“URL₁₃ PATH” refers to a truncation of a URL for a content item. In embodiments, a URL_PATH is the path to a content item excluding the protocol designation and the host server name.

“User” refers to any entity which accesses information through a communications network, including, but not limited to the Internet. A user includes but is not limited to, a human, a browser, a software system, a hardware system, or any combination of the above. The term user is frequently employed in this specification to encompass a user's system that transmits the user's request for a content item to a content provider and receives and plays or otherwise processes content items. In some contexts, the term user refers to the operator of a browser, hardware system or software system. A user may be connected to a communications network embodying the present invention through any suitable means, including without limitation voice or data communications facilities, including for example, cables, wires, fiber optic facilities, radio transmissions and wireless optical facilities.

“User access request” refers to a communication from a user that specifies a content item and a user address. For example, a user's browser connected to the Internet may send a user access request to the user's ISP where the user access request is contained in a sequence of messages exchanged between the browser and the ISP in accordance with standard Internet protocols.

“User address” refers to user identification information. For example, a user accessing the Internet is assigned an IP address designed uniquely to identify the computer or other device or system that a user is operating at the time a user access request is issued.

“User address database” refers to a data structure used in relating users to a set of one or more service points. In embodiments, a user address map resides in a commercial database or an application data structure.

“User class” refers to a category into which a user can be classified, for example for determining types of content that may be served to the user, or for charging a user for types or amounts of content served to the user.

“User profile information” refers to information about a user. In an embodiment, user profile information may be collected from publicly available sources, or from the user. User profile information can be used to provide a user with specialized content and targeted advertisements either automatically or at the request of the user.

### Acronyms

The following acronyms are frequently used in this specification to identify systems, systems and services of embodiments and illustrations of the present invention. Other acronyms are also used, as indicated in the specification. The systems, components and services thus identified do not limit the scope of the invention or its equivalents.

| | |
|---|---|
| ASB | Automated Source Block (System or Service) |
| BCC | Broadcast Control Center |
| BGP | Border Gateway Protocol |
| BMS | Broadcast Management System |
| BRAM | BCC Remote Agent Manager |
| DNS | Domain Name Server |
| EDM | Edge Data Manager |
| HREF | Hypertext Reference |
| HTTP | Hypertext Transfer Protocol |
| IHC | IRE Health Check Agent |
| ILB | IRE Load Balancer |
| ISP | Internet Service Provider |
| IRE | Internet Redirection Engine |
| NOC | Network Operations Center |
| OI | Operator Interface |
| POP | Point of Presence |
| SB | Source Block |
| SBT | Source Block Table |
| SPA | Smart Proxy Agent |
| URL | Uniform Resource Locator (also known as Universal Resource |
| | Locator) |

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the figures, like reference numbers indicate identical or functionally similar elements.

FIG. 1A provides a block diagram showing interactions between a user, a content provider, an Internet redirection engine (IRE), and a content server in an illustration of an embodiment of the present invention.

FIG. 1B provides a case diagram showing interactions between a user, a content provider, an IRE and a content server in an illustration of an embodiment of the present invention.

FIG. 2 depicts a satellite overlay network and the placement of content items at edges of an embodiment of a network according to the present invention.

FIG. 3 provides a schematic diagram depicting the relationship of components of an embodiment of a system of the present invention.

FIG. 4 provides a schematic diagram depicting the topology of an embodiment of a redirection system according to the present invention, as well as the communications flows between major components of such an embodiment.

FIGS. 5A and 5B together provide a flow diagram depicting the response of an IRE that could be used to a user access request in an illustration of the present invention.

FIG. 6 provides an overview of exemplary component relationships and information flows that could be used for updating user addresses in an embodiment of the present invention.

FIG. 7 provides an overview of exemplary component relationships and information flows that could be used for updating content item and server information in an embodiment of the present invention.

FIG. 8 depicts exemplary component relationships and information flows between a SPA, an edge node, a server and a BCC in an embodiment of the present invention.

### DETAILED DESCRIPTION OF THE DRAWINGS

With reference to the figures, a detailed discussion is presented of illustrations and embodiments of the present invention. The invention, and embodiments of it, may be implemented using software, hardware or appropriate combinations of software and hardware, and the figures and examples in this specification are not meant to limit the scope of the present invention or its embodiments or equivalents. More specifically, the systems, components, services and interactions of a redirection system embodying the present invention may be implemented using hardware, software or appropriate combinations thereof, including processors, storage devices, transmitters, receivers and other suitable components in view of this specification and the appended claims. Similarly, communication, transmission, sending, reception or other transfer of information among components, systems, devices, services or servers depicted in the figures or described in this specification may be accomplished by any suitable means, including wire, cable, fiber optic, wireless, satellite radio, infrared, light or other means, without departing from the scope of the present invention. In addition, while the drawings and examples depict and use the Internet and a satellite system as networks for use in implementing the present invention, it will be appreciated that other networks and other types of networks, including public and private networks implemented using the techniques and technologies identified above, may be used without departing from the scope of the present invention.

Embodiments of the present invention provide accelerated delivery of content items to users. This is accomplished, in response to a user access request made using the Internet for particular content items, by redirecting the user from a content provider's web-site to a second location, for example an edge node, to which the requested content items have been distributed without using the Internet. In an embodiment, content items have been distributed to edge nodes using a satellite system. The second location—e.g., the edge node—is typically more proximate to the user than the content provider's web-site. Accordingly, delivery of content items from the edge node avoids potential congestion and other problems associated with serving content items over the Internet backbone, and is designed to provide the user with a content delivery experience that the user expects as if the content items were served without congestion from the content provider's site. In an embodiment, each edge node is colocated with an ISP access point for serving a set of users, and each edge node is designated for serving the same set of users as served by the ISP.

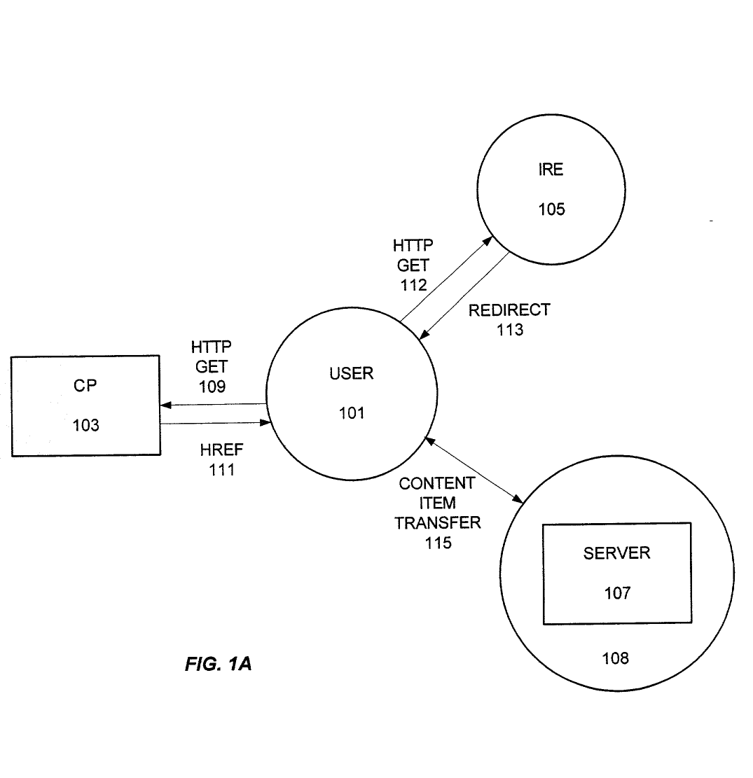

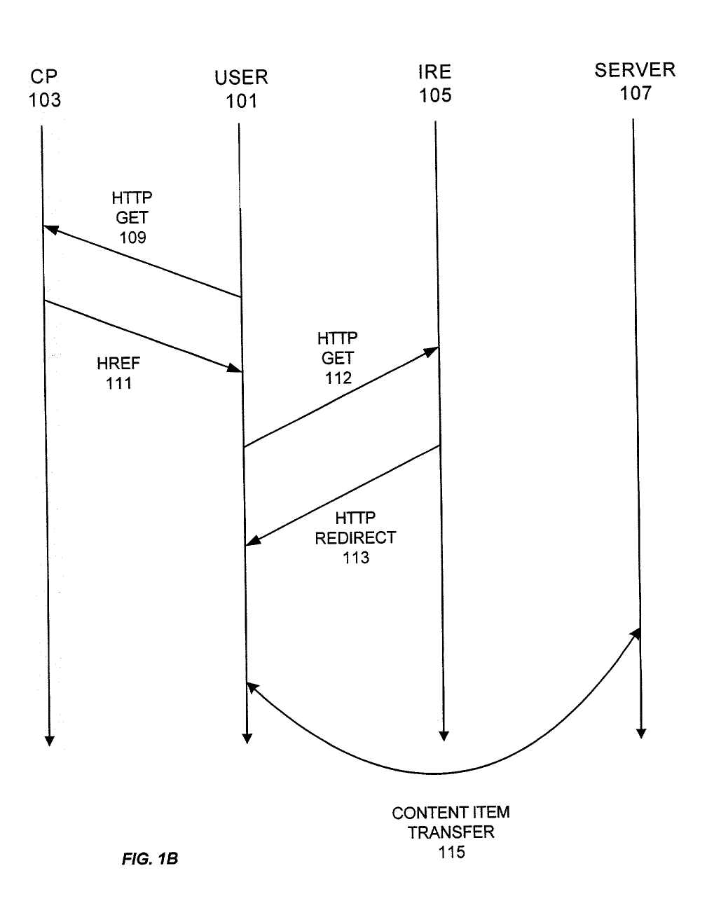

FIGS. 1A and 1B provide overviews of how embodiments of the invention process a user access request for a content item. In a simple embodiment, when a user clicks on a hyperlink at a content provider's site that refers to the content item, the user is automatically and transparently directed to an IRE as part of normal HTTP processing, and the user's browser issues an HTTP GET instruction to the IRE for the desired content item. The IRE determines the most proximate server where the content Item is available and directs the user to that server for the content item.

As depicted in FIG. 1A, a simple embodiment can comprise User 101, Content Provider (“CP”) site 103, IRE 105, and Server 107 at edge Node 108. In the embodiment depicted in FIG. 1A, a user access request (in this depiction HTTP GET 109) to CP site 103 causes Hypertext Reference (“HREF”) instruction 111 to be sent to User 101, which automatically and transparently directs User 101 to transmit information in the user access request to IRE 105. This transmission is HTTP GET 112, which, like HTTP GET 109, includes the user address and a specification of the content item. In response, IRE 105 sends Redirect instruction 113 to User 101, redirecting User 101 to initiate the specified Content Item Transfer 115 from Server 107 at Edge Node 108.

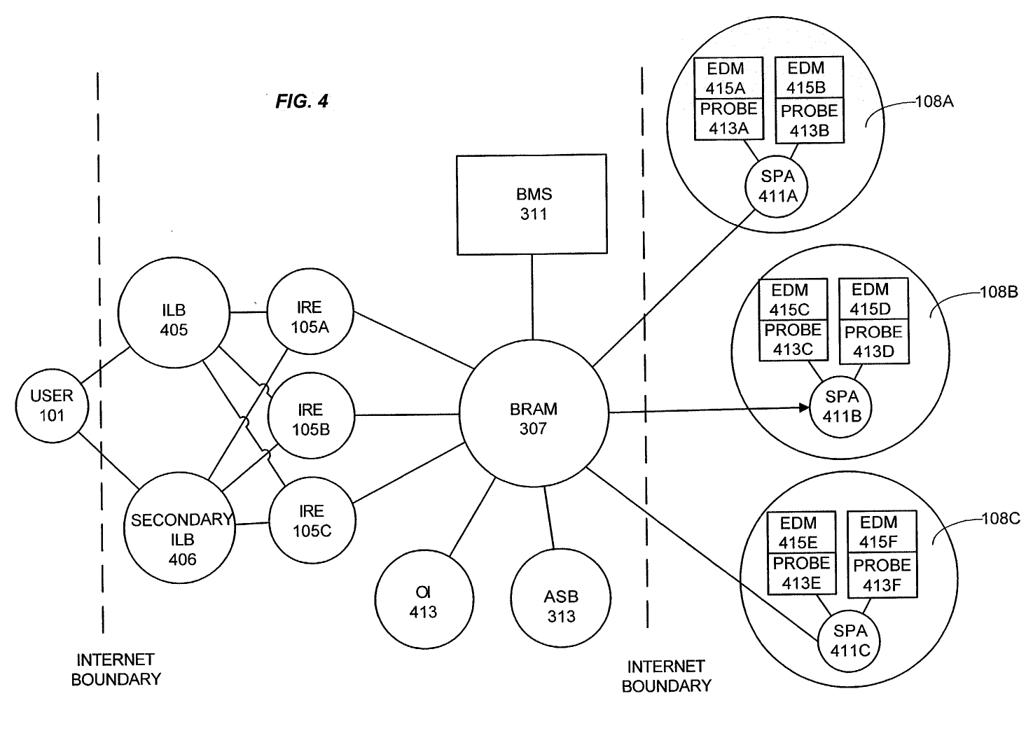

More specifically, in the embodiment depicted in FIG. 1A, User 101 submits a user access request for a content item by making an input on his Internet browser, either by typing in a URL or by clicking on a hyperlink at a CP site 103, thereby generating HTTP GET 109. In an embodiment, the request by User 101 travels over the Internet to CP site 103, which has an arrangement with a redirection system including IRE 105 to provide redirection services. In other embodiments (not depicted) a user access request may be submitted by other signaling and telecommunications means, including for example voice entry and recognition or telephone keypad signaling. As depicted in FIG. 1A, CP site 103 returns HREF 111 to User 101, which directs User 101 to an IRE of the redirection system. In the embodiment depicted in FIG. 1A, the redirection system includes a single IRE 105. (An example of a redirection system with multiple IREs is depicted in FIG. 4.) Upon receiving HREF 111, User 101 generates HTTP GET 112 and transmits it to IRE 105. In an embodiment, this generation and transmission are automatic and transparent to the operator of User 101's browser or other system. HTTP GET 112 includes information about the user address and the content item specified in the user access request. Using this information in combination with information stored in databases available to IRE 105, IRE 105 determines the edge node associated with User 101 and proximate to User 101 that includes a server that has the requested content item. For example, after IRE 105 has determined the edge node proximate to User 101, IRE 105 determines, based on information stored in a content item database (not depicted in FIG. 1A), whether one or more servers at that edge node has the requested content item. If so, User 101 is redirected to one of those servers. For example, in the embodiment depicted in FIG. 1A, User 101 has been redirected to Server 107 located at Edge Node 108. Server 107 and User 101 communicate via Content Item Transfer 115 to serve the requested content item to User 101.

In an embodiment, IRE 105 runs as a multi-threaded Java servlet in the context of a fast, lightweight HTTP server and Java servlet manager. The HTTP server handles HTTP requests and forwards HTTP GET instructions to databases and processors in or available to IRE 105 that issue HTTP redirect instructions, as described above with reference to FIG. 1A, or issue container files enabling redirection instructions to users to be written, as explained below.

FIG. 1B depicts the information flows depicted in FIG. 1A in case diagram form. User 101 transmits HTTP GET 109 to Content Provider 103, requesting a content item. Content Provider 103 responds with HREF 111, instructing User 101 to request the location of the content item from IRE 105. In the embodiment depicted in FIG. 1B, User 101 then transmits HTTP GET 112 to IRE 105, which determines that Edge Node 108 (depicted in FIG. 1A) is proximate to User 101 and that Server 107 has the content item. IRE 105 then responds with HTTP Redirection instruction 113 to User 101, providing User 101 with the address of the content item in Server 107 of Edge Node 108. Through Content Item Transfer 115, User 101 and Server 107 communicate in order to serve the requested content item to User 101.

In an embodiment (not depicted), nodes may be arranged hierarchically in layers. In an example of such an arrangement, (a) one or more edge nodes would comprise the lowest layer; (b) one or more regional nodes would comprise an intermediate layer with each edge node associated with a single edge node; and (c) a center node would comprise the highest layer, with each regional node associated with a single center node. Each node may house one or more servers, depending on projected traffic, storage requirements, security considerations and the like, from which content items may be served to users. In embodiments, an edge node is colocated with or located at a location proximate to the location from which an ISP serves a specified set of users. For example, the first access point for a specified set of users of an ISP may be a point of presence (“POP”) maintained by the ISP at a physical location. In an embodiment, servers are colocated with and connected to the ISP's POP, and are configured to be able to communicate with the specified set of users served from the ISP's POP. In such an embodiment, the location of the ISP's POP and the servers is designated as an edge or an edge node. In an embodiment, content items located at an edge node are only served to users who are associated with the ISP whose POP serves as the location of the edge node. In embodiments, a regional node communicates with a plurality of edge nodes and thus can potentially serve users of a plurality of different ISPs. In embodiments, a center node communicates with a plurality of regional nodes, and thus can potentially serve an even wider array of users. As is apparent in view of this specification and the claims, the present invention may be implemented using alternate hierarchies and arrangements of layers. The redirection system could operate such nodes, or could have appropriate arrangements with ISPs or other operators of edge, regional or center nodes.

In an example of the arrangement described above involving three layers, if the requested content item is not at the edge node associated with the user requesting the content item, then an IRE would determine whether the requested content item is at a regional node associated with the edge node. If the content item is at the regional node, the user would be redirected to a server at the regional node having the requested content item. If the content item is also not found at this regional node, the user would be redirected to and served from the center node associated with the regional node.

An embodiment of the invention uses a container file to specify to the user where to obtain the various components that may be needed in order to retrieve, play or process the one or more content items requested by the user or might otherwise be designated for the user in response to a user access request. For example, a media player might be needed in order to play a requested content item; or a advertisement might be needed from another web-site in order to be inserted into a banner space in a content item. In such cases, the user would be served with a container file that provides the appropriate addresses for the different components of the response to the user access request. As explained in more detail below, the contents of a container file may be generated in several ways. For example each of the elements of a container file could be retrieved from a database at an IRE or available on a shared basis with an IRE and other components of a redirection system embodying the present invention. As another example, each of the elements of a content file could be retrieved, along with the content items themselves, from appropriate storage at an edge node.

In another example, the addresses in a content file of content items, players and other components could be determined “on the fly” in near real time upon receipt of a user access request, in response to factors such as congestion and other conditions including server health and server load at relevant edge nodes, the disposition of content items at relevant nodes, and information in a user profile. In this example, generic container files could be centrally stored in the redirection system, with macros or other programs that could be executed at the time of a user access request to provide the URL of each content item, player or other application or file identified by the container file as responsive to the user access request.

In a further example, and again with reference to FIG. 1A, a container file could be stored at Server 107 at Edge Node 108, with the container file specifying Server 107 (or another server) as the location of the content items identified in the container. In this example, when a user access request is received by IRE 105, it does not serve a container file to User 101. Rather, IRE 105 transmits an HTTP redirect instruction (such as Redirect instruction 113 ) to User 101, giving the address of Server 107 as the location of a container file responsive to the user access request. This container file could be hard coded with the URL of Server 107 (or another server). If a requested content item is not at Server 107, however, the container file could also be hard coded with the address of another server, a regional node or a center node where the requested content item is available to be served to User 101.

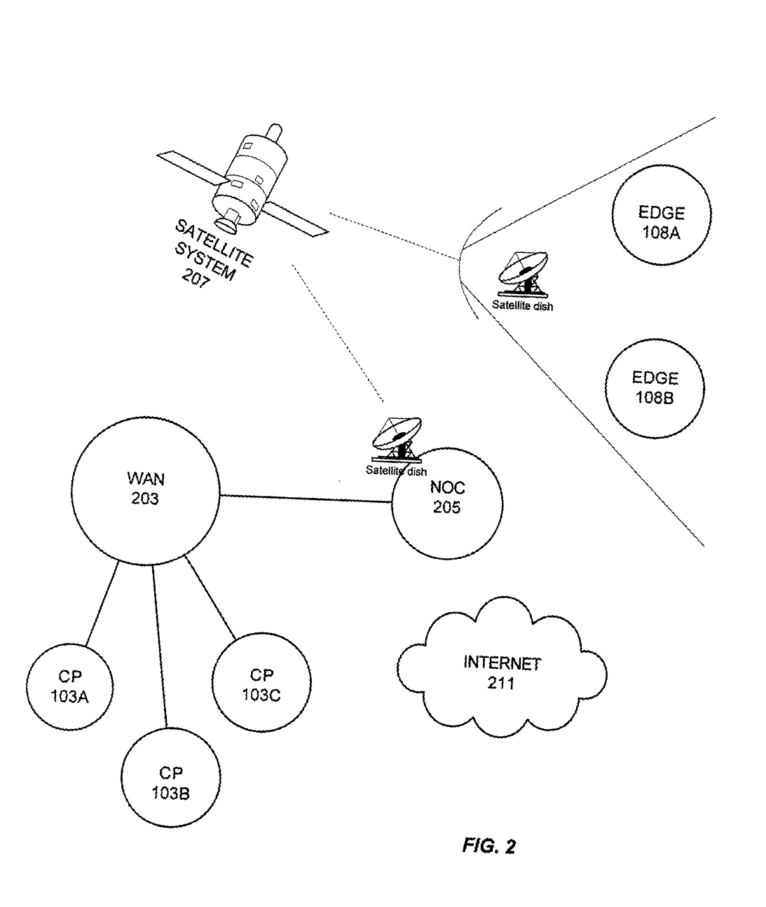

FIG. 2 depicts an embodiment of a system and method of the present invention for distributing content items to edge nodes and other nodes in a manner that does not require use of the Internet or other network used to handle user access requests (including for example HTTP, HREF and redirect information flows depicted in FIGs. 1A and 1B). In an embodiment depicted in FIG. 2, Wide Area Network (“WAN”) 203 is an ATM-based network consisting of permanent virtual circuits of varying throughputs. As shown in FIG. 2, content items are placed at both or either of Edge Node 108A and Edge Node 108B in a manner that bypasses the Internet 211. Content Providers 103A, 103B and 103C, for example under agreement with a provider of a redirection service, provide content items to WAN 203, which passes them, through permanent virtual circuits that do not use Internet 211, to Network Operations Center (“NOC”) 205. From NOC 205, the content items—along with instructions on where to place them—are sent to Satellite System 207. These instructions are designed to effectuate the goals of the redirection system of accelerating the delivery of content items to users. Particular sets of instructions will be apparent in view of this specification and the appended claims. For example, in an embodiment, the instructions would direct the distribution of each content item to at least one server at each edge node, regional node and center node in order to assure minimal delay in the delivery of content items to users. In other embodiments, the instructions for particular content items could reflect an agreement between the content provider of those items and the operator of a redirection system embodying the present invention.

As depicted in FIG. 2, based on instructions from NOC 205, Satellite System 207 broadcasts the content items and storage instructions to each of Edge Nodes 108A and 108B, bypassing Internet 211. In such an embodiment, the storage instructions from NOC instruct which Edge Node 108A or Edge Node 108B, or both to store each content item transmitted via Satellite System 207. In an embodiment implemented on a global scope, a system implementing the present invention may comprise as many as 25,000 or more servers, in 5,000 or more nodes. In an embodiment, Satellite System 207, including Network Operations Center 205, is available from and operated by PanAmSat.

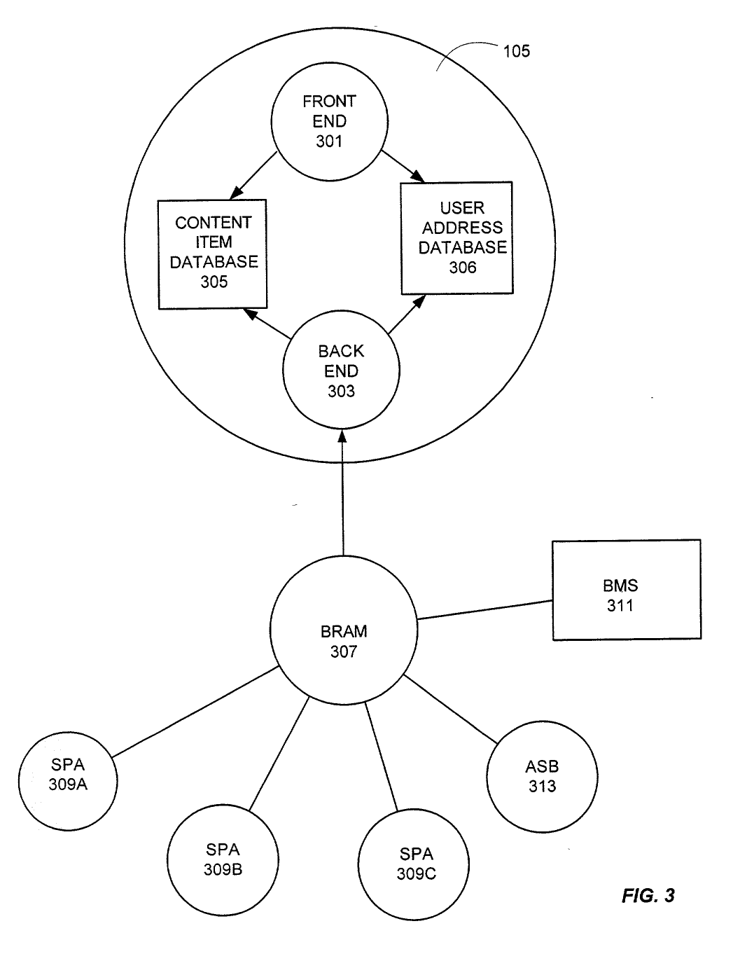

FIG. 3 presents an overview of components of an embodiment of a system according to the present invention. As described in more detail below, the system comprises IRE 105, having a Front End 301 and a Back End 303, Content Item Database 305 and User Address Database 306. These databases contain information read by IRE Front End 301 and used to determine the server to which a user will be redirected for a requested content item, for example as described above with respect to FIGS. 1A and 1B. As depicted in FIG. 3, each Smart Proxy Agent (“SPA”) 309A, 309B and 309C is associated with one or more servers at a node, and provides information to BRAM 307 concerning the health of each server associated with the SPA, as well as the disposition of content items stored on each of those servers. In the embodiment depicted in FIG. 3, Broadcast Management System (“BMS”) 311 provides information to BRAM 307 on the placement of content items at various servers and nodes. In embodiments, BRAM 307 receives this information from NOC 205, depicted in FIG. 2. As depicted in FIG. 3, BRAM 307 receives updated information on user addresses, including information on the users associated with each node, from Automated Source Block System (“ASB”) 313. BRAM 307 uses the information received from these sources to update Content Item Database 305 and User Address Database 306 of IRE 105. In the embodiment depicted in FIG. 3, BRAM 307 receives information relating to server health and content disposition from each SPA 309A, 309B and 309C, information relating to content placement from BMS 311, and updated source block information (e.g., user address information) from ASB 313. BRAM 307 uses the information received from these sources to update Content Item Database 305 and User Address Database 306 of IRE 105 through IRE Back End 303.

For example, Content Item Database 305 appears, when read by IRE Front End 301 for redirection determinations, as a “static table” that contains data regarding where (i.e., on which server, and/or edge node) each content item can be found. When BRAM 307 receives a report from BMS 311 or from a SPA 309A, 309B or 309C necessitating a change in Content Item Database 305 (for example, that a particular content item has been placed at a particular location, or that a given server is not available), BRAM 307 sends that information to IRE 105, which updates Content Item Database 305 from Back End 303 accordingly. Similarly, User Address Database 306 appears to IRE Front End 301 as a static table that contains data associating sets of users with particular edge nodes. When BRAM 307 receives information from ASB 313 that updates the association between users and edges (for example, adding or deleting users), BRAM 307 sends that information to IRE 105, which updates User Address Database 306 from Back End 303 accordingly.

As a result of configurations like the one depicted in FIG. 3, an IRE according to the present invention has available to it, in near real time if desired, updated information on the location of users, the association of users to nodes, the status of servers, the location and disposition of content items, and other information needed to make redirection determinations in response to user access requests. By separating the functions of updating and accessing the relevant databases—that is, updating through a “back end” engine, and accessing for redirection determinations through a “front end” engine—the databases can be accessed for redirection determinations essentially as if they were static, which further increases the speed of the redirection process.

A more detailed topology of components of an embodiment of a system implementing the present invention is shown in FIG. 4. As shown in FIG. 4, an embodiment of the system comprises a plurality of centrally located components, including BRAM 307, Operator Interface (“OI”) 413; IREs 105A, 105B and 105C; IRE Load Balancer (“ILB”) 405; Secondary ILB 406; BMS 311; and ASB 313; and a plurality of distributed components located at Edge Node 108A (including SPA 411A, Smart Probes 413A and 413B and EDMs 415A and 415B); Edge Node 108B (including SPA 411B, Smart Probes 413C and 413D and EDMs 415C and 415D); and Edge Node 108C (including SPA 411C, Smart Probe 413E and 413F and EDMs 415E and 415F). In the embodiment shown in FIG. 4, ILB 405 and Secondary ILB 406 are configured for communication with User 101.

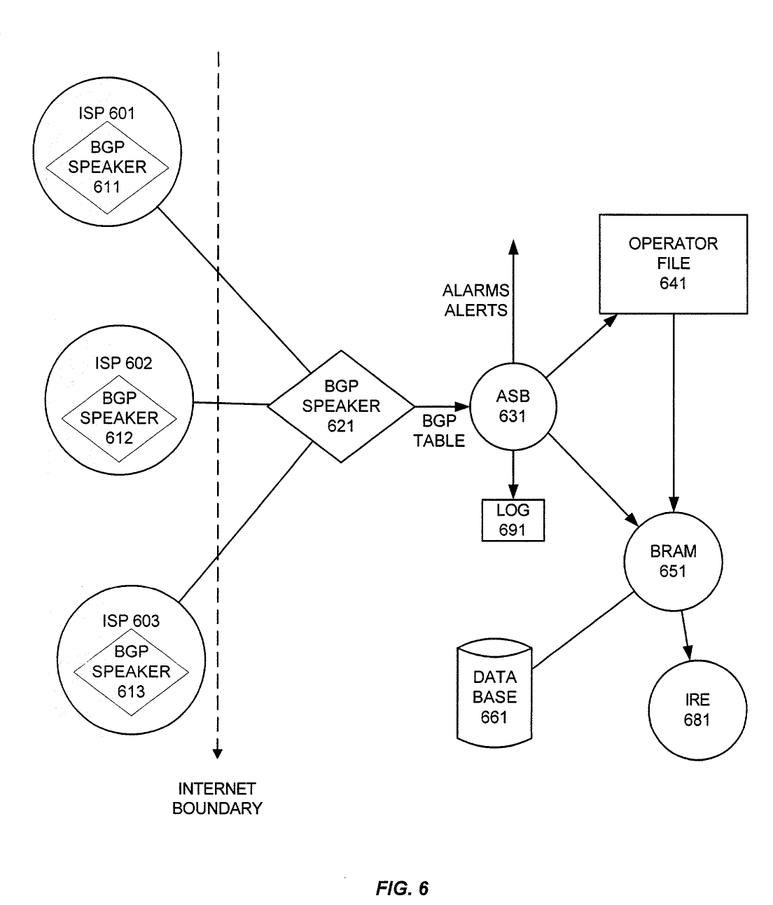

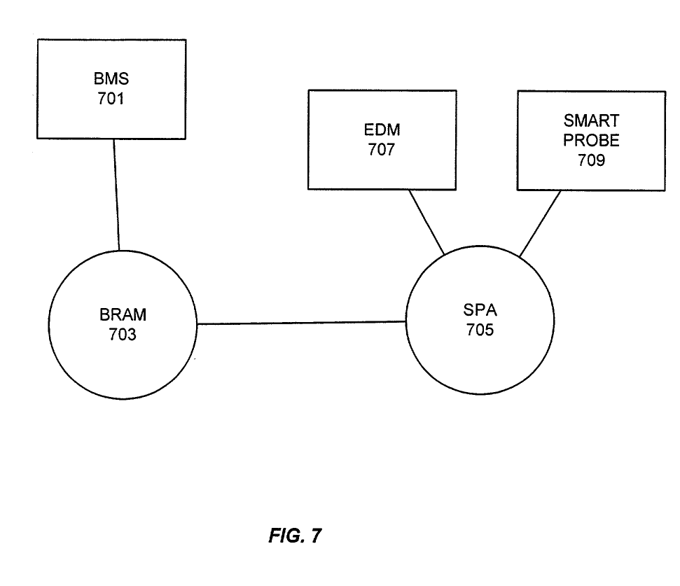

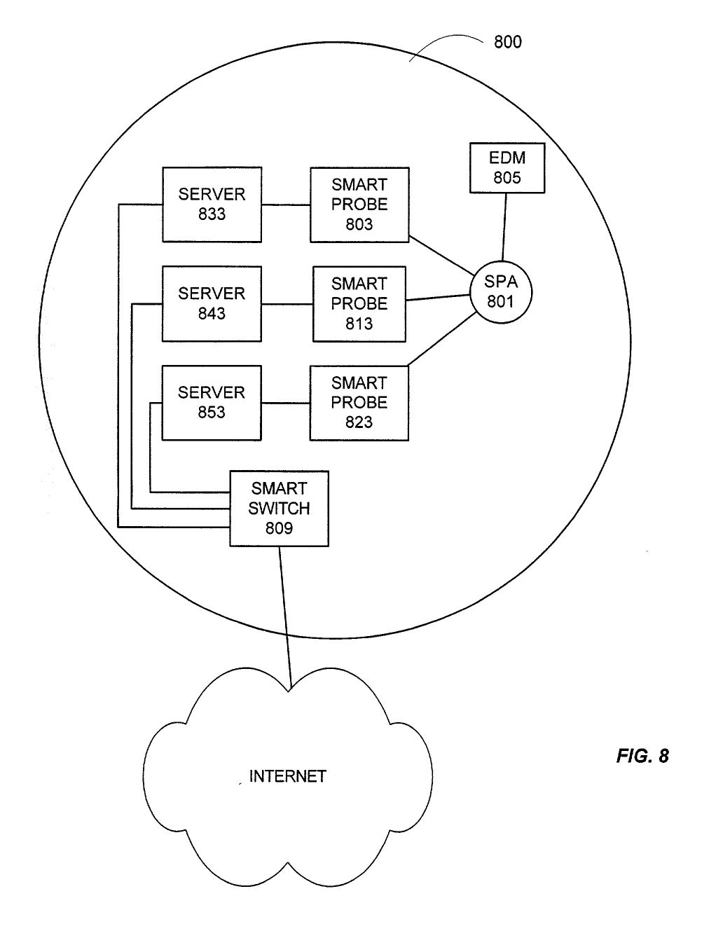

In an embodiment, BRAM 307 is a multi-threaded, multi-protocol engine that acts as a central messaging and control mechanism for the system. As discussed above in connection with FIG. 3, BRAM 307 supplies information to IREs 105A, 105B and 105C on which they base their redirection determinations, including information relating to conditions at Edge Nodes 108A, 108B and 108C, such as server status and health, load information and content item disposition. BRAM 307 receives information relating to conditions at Edge Nodes 108A, 108B and 108C (such as server health, server load, content item disposition) from SPAs 411A, 411B and 411C, which in turn receive information from Smart Probes 413A and 413B located on servers at Edge Node 108A, Smart Probes 413C and 413D located on servers at Edge Node 108B and Smart Probes 413E and 413F located at Edge Node 108C. In addition, SPAs 411A, 411B and 411C pass information from EDMs 415A and 415B, EDMs 415C and 415D and EDMs 415E and 415F, respectively, to BRAM 307. In the embodiment depicted in FIG. 4, BRAM 307 receives information that relates user address information to specific edge nodes from ASB 313. The relationships and interactions between BRAMs and ASB systems is described in more detail below with reference to with FIG. 6. The relationships and interactions between servers, smart probes, edge data managers, and smart proxy agents is discussed in more detail below with reference to FIGS. 7 and 8.

In the embodiment depicted in FIG. 4, OI 413 enables an operator manually to communicate with BRAM 307, for example to configure BRAM 307 or manually to access and/or make changes to the databases maintained by BRAM 307. In an embodiment, OI 413 is a Java application. In appropriately configured embodiments, BRAM 307 is coupled to Content Item Database 305 and User Address Database 306 (shown in FIG. 3) via a JDBC interface (depicted in FIG. 3 as Back End 303 ). In an embodiment, information can also be entered into Content Item Database 305 and User Item Database 306 directly by means of SQL statements.

BRAM 307 also exchanges information with BMS 311 about the placement of content items. In an embodiment, software for the BMS is written in object oriented programming code, such as portable Java. In an embodiment, components of a redirection system of the invention communicate with each other over TCP or UDP and may use a protocol developed for the purpose. A suitable protocol is BRAM-talk protocol, available from BBN Technologies, 10 Moulton Street, Cambridge, Mass. 02138.

In the embodiment depicted in FIG. 4, IRE Load Balancer (“ILB”) 405 and Secondary ILB 406 (with Secondary ILB 406 serving as a backup to ILB 405 ) serve to balance the load between IREs 105A, 105B and 105C. In embodiments, ILB 405 and Secondary ILB 406 detect failures of an IRE 105A, 105B or 105C, and provide failover protection by directing traffic away from a failed or overloaded IRE 105A, 105B or 105C.

In an embodiment, each of ILB 405 and Secondary ILB 406 comprises a DNS server and an IRE Health Check agent (“IHC”) (not depicted). The receipt by ILB 405, for example, of a user access request from User 101 causes ILB 405 to look up the domain name of an IRE 105. In an embodiment, ILB 405, equipped with a Domain Name Server (“DNS”), adapted as apparent in light of this specification, returns the IP address of each of IRE 105A, 105B and 105C in a round robin fashion. In embodiments, the TTL (time to live) of the DNS address record of the IRE domain name is quite small, for example 20 seconds by default, so that when users return very quickly, another lookup is not required from the primary DNS of ILB 405. Users that return in longer time frames may be directed to another IRE 105A, 105B and 105C, thus helping to balance the load among IREs 105A, 105B and 105C.

In embodiments, failover protection is provided in connection with an IRE Health Check System (“IHC”), which can either be part of the DNS Server of ILB 405, for example, or run as a separate process. In embodiments, the IHC periodically obtains health information from one or more IREs 105A, 105B and 105C. In embodiments, the health information is sent via site-scoped multicasting, which eliminates the need for a separate communication protocol to be opened between an IRE and an ILB; the IHC simply multicasts a signal, without any need to know what component will receive it. The multicast signals from the IHC may be periodic, and in the form of a heartbeat indicating presence, and may also indicate that the next heartbeat will be heard in a specified interval. If, after the specified interval, ILB 405 or Secondary ILB 406 has not heard the heartbeat again, the IHC directs ILB 405 or Secondary ILB 406 to select another one of IRE 105A, 105B, or 105C for handling further user access requests, and removes the failed IRE 105 from the ILB server's round-robin list. An ILB that would serve the purpose of the present invention can be configured, as is apparent in view of this specification, from a smart switch with a failover protocol, such as the Series 11000 switch available from Cisco Systems, Inc.

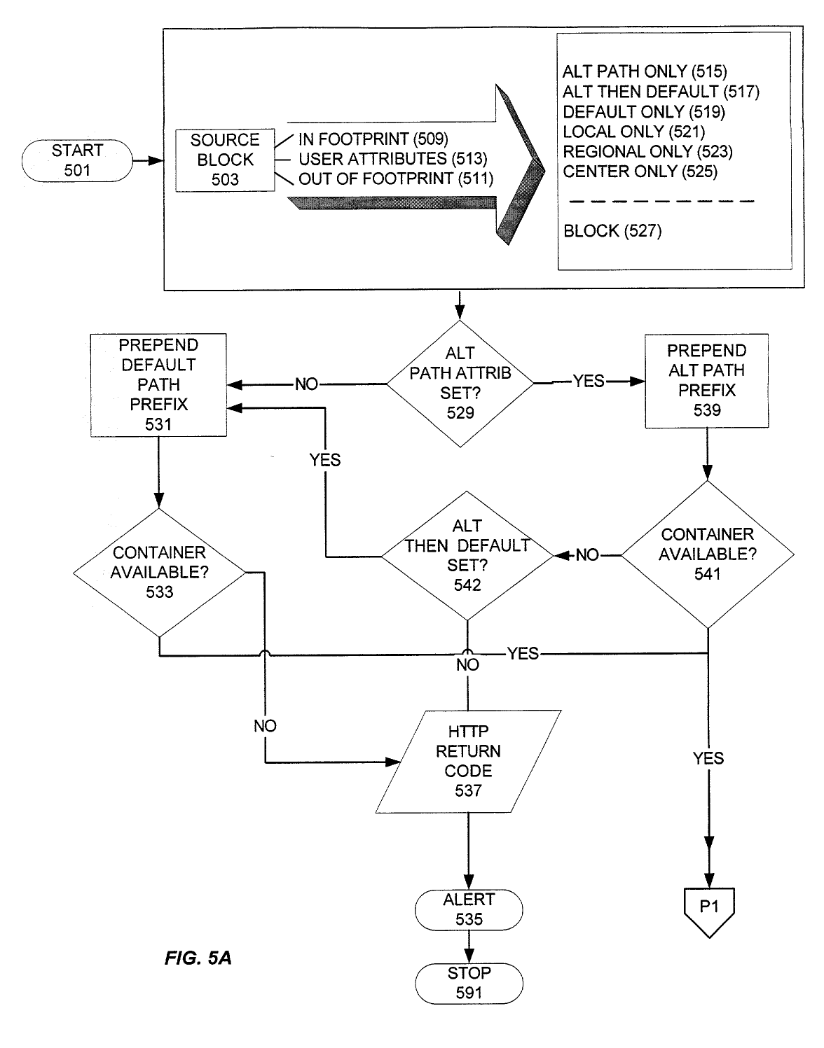

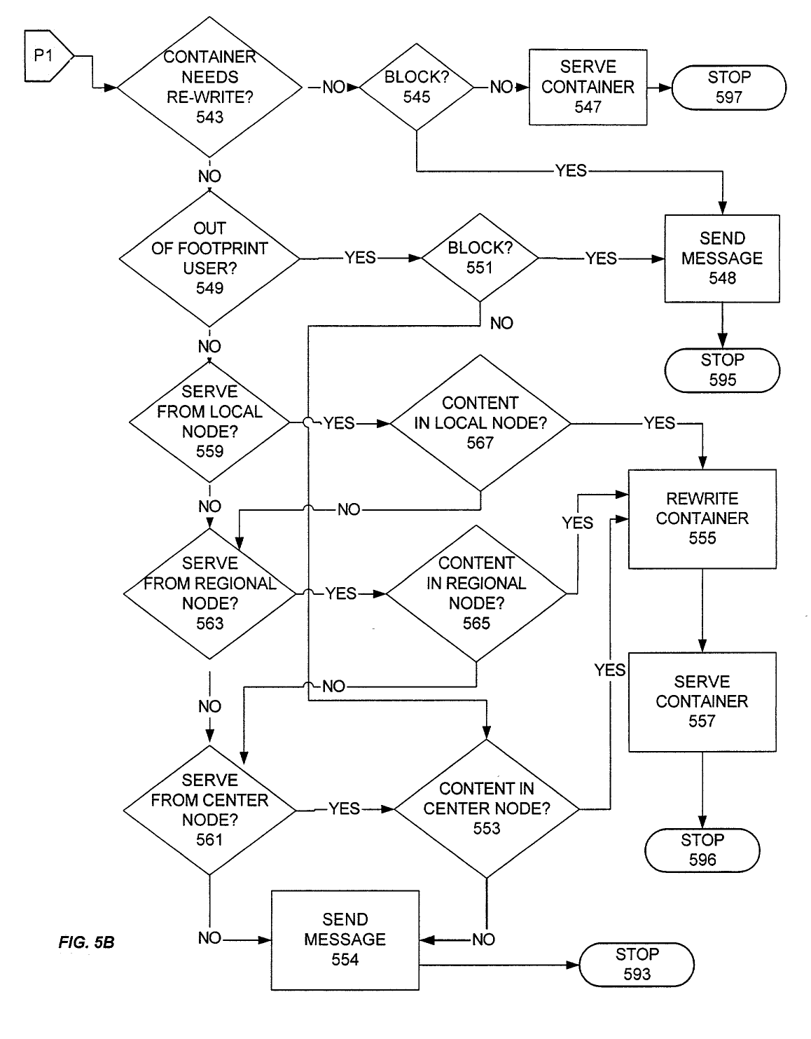

FIGS. 5A and 5B together provide a flow diagram depicting the response of an embodiment of an illustrative IRE according to the present invention to an illustrative user access request. As discussed in connection with FIG. 1, in embodiments of the present invention, when a user makes a user access request to a content provider site, the request is redirected in the form of a HTTP reference to an IRE (such as IRE 105 of the embodiment depicted in FIG. 1). From the HTTP reference, the IRE extracts user ID information associated with the user, as well as content information identifying the requested content item. From User Address Database 306 (depicted in FIG. 3), the IRE can determine the source block associated with the user. As used in this specification, a source block refers to a mapping of a group of user addresses to a node. In embodiments, a source block maps a group of user IP addresses to an edge node, a regional node and/or a center node. Accordingly, in FIG. 5A, Start 501 identifies the point at which Source Block 503 and the URL of the requested content item, associated with its URL_PATH, have been identified by an IRE based on the user access request.

From Source Block 503, in embodiments an IRE can determine whether the user is associated with an edge node or regional node in a particular redirection system. If so, the user may be said to be “in footprint” (509). If not, the user is said to be “out of footprint” (511). In embodiments content items are served out of footprint from a center node.

In an embodiment, Source Block 503 can also yield a path-prefix, if one is assigned, for the range of IP addresses mapped by Source Block 503. This allows special directories to be established for serving specific content to specific sets of users based on their IP address range (which could be a single IP address). Accordingly, in an embodiment, Source Block 503 yields User Attributes 513 for each user whose address is in the range mapped by Source Block 503. User Attributes 513 may comprise information, read by the IRE, that plays a role in the IRE's determination of the server from which to serve the content item requested by the user. For example, in the embodiment depicted in FIG. 5A, attributes include “Alt Path Only” (515), “Alt Then Default” (517), “Default Only” (519), “Local Only” (521), “Regional Only” (523), “Center Only” (525) and “Block” (527). In this example, a normal or default path and an alternate path are specified for serving content items to a user. These paths may differ in characteristics such as transmission speed, bit error rate and cost. If “Alt Path Only” attribute 515 is selected, the content item will be served to the user only from the alternate path; if the content item is not available via the alternate path, the user will not be served. Alt Path Only attribute 515 can be useful in cases where the user has specified that she will only accept content above a specified quality. If Alt Then Default attribute 517 is selected, the system (e.g., the IRE) first checks to see if the requested content item is available on the alternate path; if the content item is not available over the alternate path, the user is served over the default or normal path.

a path-prefix to the URL_PATH provides the ability to serve different content items to a certain set of users. For instance, in some embodiments, an out-of-footprint user requesting a content item may receive a response that includes a brief excerpt of the content item at the transmission speed for in-footprint users, then a short hypertext note, followed by the full content item at a slower transmission speed, thereby providing a demonstration of the advantages of becoming an in-footprint user. In other embodiments, in-footprint users who pay a special fee could receive content items at higher quality streams. In yet other embodiments, users can be segregated and served differently based on their geographic location.

In embodiments, “Local Only,” “Regional Only” and “Center Only,” attributes 521, 523, and 525 can be used to specify that a user (or group of users in a source block) are served from a node in a designated layer and not from a node in a different layer. “Block” attribute 527 may be used to prevent a user from receiving certain content.

Specifically, as shown in FIG. 5A, an IRE at step 529 determines whether an Alt Path Attribute (in this example, Alt Path Only attribute 515 or Alt Then Default attribute 517) has been set. If the answer is no, or if Default Only attribute 519 is set, then at step 531, a Default Path prefix is prepended to the URL_PATH, and the IRE checks at decision box 533 whether a container is available for the requested content item.

In an embodiment, a container is a file that includes a playlist comprising a list of URLs, where each URL specifies the location (including the server) of each content item responsive to a user access request. In embodiments, a container also includes the URL of an application needed to play or otherwise process the corresponding content item. In embodiments, each URL in a container is hard coded, that is, specified in advance of the use of the container and is expected to change infrequently. In other embodiments, the URL of one or more content items (or applications) in a container are determined as a result of the execution of a macro or other program whose resulting URL (including for example, the URL of another container) may depend on a variety of inputs, such as path information, user profile information, and server health and load information. For example, a macro for a content item in a container responsive to a user access request may determine that the user is also to receive an advertisement as a trailer to the content item or that, because of the load at the time on servers at the edge node otherwise most proximate to the user, the content item should be served from another node. As discussed below, a macro in a container may also have as input information from a user profile, which, for example, enables the user to be served Pay-Per-View or special event content items.

In an embodiment, the IRE scans the container file for the macro keywords (for example, the characters “$$IP[:PORT]$$”) and replaces them with the IP address associated with a URL_PATH server and port if a port is specified in the IRE tables. After rewriting the container file, the IRE looks up the type of content corresponding to that container from its internal tables or from the extension in the content file name extracted from the URL in the HTTP GET request and determines the corresponding MIME type for type of content for the requested content item.

In embodiments of the present invention, any or all of the redirection determinations, the container file served to the user, or the contents of the container file served to the user, may depend on user profile information, including age, gender, content or other preferences, income or other information about users that may be useful or desirable in offering content, features or options to users of a redirection system of the present invention. For example, if parents have determined that certain types of content are not to be served to their home computer, this could be reflected in a user profile corresponding to that computer. As another example, information in a user's profile could trigger a response to a macro in a container that would redirect the user to alternate content, or a different version (e.g., in a different language or with subtitles) of the content specified by the user. As a further example, in response to user profile information an IRE could select a container customized to the particular user that would include references for example to advertising content specifically tailored or responsive to the user profile for insertion into a content item requested by the user, or might include content item entries for the particular user that would not be found in a container retrieved in response to a different user's request. Thus, embodiments of the system and method of the present invention can provide tailored content redirection, optionally in a manner transparent to the user, responsive to user profile information as well as a user address and a requested content item.

In other embodiments, a container may include encrypted information or a URL or macro that determines a URL of encrypted information. For example, a container may include an encrypted counter that keeps track of a balance in a deposit account that is to be debited if the user selects a content item that is available on a pay per view, subscription or other charge basis. When the user selects such a content item, the counter or account balance could be reduced by the appropriate amount, either automatically or in response to a password entry by the user. When the counter or account balance is reduced to a predetermined level, the user could be automatically prompted to enter appropriate information, such as a credit card or debit card number, to increase the count or account balance.

User profile information can be made available in a number of ways to a redirection system embodying the present invention. In an embodiment, if a user access request includes a user address not included in the user address database(s) of the system, then the user could be presented with a dialog screen that would request and obtain profile information, which would be stored for tailored content redirection, as described above. Users who had provided profile information could also be prompted periodically to update their profile information.

In other embodiments, a component of the system, for example a SPA at a node associated with a user by an ASB System, could include a database that keeps track of the content items requested by the user. This information for example could be included with the user's profile information, and redirection determinations could also be responsive to this information or could be used to suggest to the user content items instead of or in addition to the content items selected by the user.

In the embodiment depicted in FIG. 5A, at step 533 an IRE determines whether a container is available in connection with a user access request. This typically entails accessing a content item database (such as Content Item Database 305 of FIG. 3) to determine whether the requested content item is available on a server in a node. If a container is not available—which may occur for example if the link to the content provider is out of date, or if there is system configuration error—the IRE generates Alert 535, based on an HTTP 404 Return Code (step 537) for example, and processing stops at step 591. In embodiments, if a container is not available, the IRE or other component also generates a site-scoped multicast message to inform a BRAM or other components, services or applications of the condition. Returning to step 533, if a container is available, the processing of the user access request continues at step 543 in FIG. 5B by way of flow chart connector P1, and as described below.

Returning to step 529 of the embodiment depicted in FIG. 5A, if a Alt Path Attribute is set, then at step 539 the IRE prepends the Alt Path-Prefix to the URL_PATH, and checks at step 541 to see if a container is available for the requested content item in the alternate path. If a container is not available in the alternate path, and the Alt Path Only attribute 515 has been set (and consequently that the Alt Then Default attribute 517 has not been set), at step 537 the IRE generates HTTP 404 Return Code and Alert 535, processing stops (step 591) and the user will not receive the content item. In an embodiment, the return code informs the network (for example BRAM 307 depicted in FIGS. 3 and 4) that the requested content item is not available at the alternate path, and which in turn prompts an appropriate component (again such as BRAM 307) to take action to correct the condition for future user access requests. If the container is available on the alternate path, processing continues at step 543 in FIG. 5B via flow chart connector P1 as described below.

Returning to step 541 of the embodiment depicted in FIG. 5A, if the container is not available on the alternate path, and if the IRE determines at step 542 that the Alt Then Default attribute 517 has been set, then at step 531 the IRE prepends the Default Path prefix to the URL_PATH and proceeds from step 531 in the manner described above for cases where Alt Path attribute 515 or Alt Then Default attribute 517 have not been set, or Default Only attribute 519 has been set.

In the embodiment depicted in FIG. 5B, in the case using either the default path or the alternate path, if a container is available, then at step 543 the IRE determines whether the container needs to be rewritten. This may be done by scanning the container for macros, which indicate the presence of soft-coded URLs. In the embodiment depicted in FIG. 5B, if the IRE determines that the container does not need to be rewritten (i.e., that it contains only hard coded URLs), at step 545 it next checks if Block attribute 527 has been set in order to block the user from viewing the requested content. If Block attribute 527 has not been set, then the IRE serves the container to the user's browser (step 547), and the user's browser accesses the requested content items (including, as appropriate, players) based on the URLs in the container, and processing stops at step 597. If Block attribute 527 has been set to block the user from viewing the requested content, the user is blocked from viewing it, and at step 548 the user receives a message explaining the block, and processing stops (step 595).

Continuing with the exemplary embodiment depicted in FIG. 5B, if at step 543 the IRE detects macros in the container—signifying the presence of soft-coded URLs—the IRE considers at step 549 whether the user is out of footprint and thus in this embodiment is to be served from a center node. If the user is out of footprint, the IRE at step 551 checks if Block attribute 527 has been set in order to block the user from viewing the requested content. If Block attribute 527 has been set, the user is blocked, at step 548 the user receives a message to that effect, and at step 595 processing stops. Returning to step 551, if Block attribute 527 has not been set, the IRE determines whether the requested content item is at the center node (step 553). If so, then at step 555 the IRE rewrites the container file with URLs specifying the location(s) of the requested content item (and players) and at step 557 serves the container to the user, who has now been redirected from a content provider to the center node. At step 596 processing would then stop.

Returning to step 549 of the exemplary embodiment depicted in FIG. 5B, if the user is determined to be in footprint, the IRE evaluates Local Only attribute 521, Regional Only attribute 523, and Center Only attribute 525 to determine how to process the user request further for each piece of content specified in the container file. For example, if Regional Only attribute 523 has been set, then Serve From Local Node? step 559 would return “No,” as would Serve From Center Node? step 561, while Serve From Regional Node? step 563 would return “Yes.” Under such circumstances, the IRE would at step 565 check a content item database (such as Content Item Database 305 depicted in FIG. 3) to determine whether the requested content item is in a regional node. If so, the IRE would in embodiments rewrite the container file (step 555) and at step 557 serve the rewritten container file to the user. If, at step 565, it is determined that the requested content item is not at a regional node, then processing would continue at step 561, where Serve From Center Node? 531 would return a “No,” in this example, since Regional Only attribute 523 has been set. Then, at step 554 the user would receive an appropriate message and processing would stop at step 593.

Continuing with the exemplary embodiment, if none of Local Only attribute 521, Regional Only attribute 523 and Center Only attribute 525 is set, then Serve From Local? step 559 returns a “Yes” value, and the IRE determines, at step 567, whether the requested content item is available at the local (or edge) node (including, for example, whether the local (or edge) node is operational). If so, then at step 555 the IRE rewrites the container to specify the local (or edge) node and proximate server for the content item, and at step 557 serves the rewritten container to the user, and at step 596 processing stops. If the IRE determines at step 567 that the requested content item is not available at the local (or edge) node, then it proceeds to Serve From Regional Node? step 563, which would return a “Yes” value since, in this example, neither Local Only attribute 521 nor Center Only attribute 525 is set. The IRE would then determine, at step 565, whether the requested content item is available at the regional node. If so, then at step 555 the IRE rewrites the container to specify the regional node and proximate server for the content item, and at step 557 serves the rewritten container to the user, and at step 596 processing stops. If the IRE determines at 565 that the requested content item is not available at the regional node, then it proceeds to Serve From Center Node? step 561, which returns a “Yes” value since in this case Local Only attribute 521 and Regional Only attribute 523 are not set. The IRE then determines at step 553 whether the requested content item is available at the center node. If so, the container is rewritten at step 555 to specify the center node and proximate server for the requested content item, and at step 557 the container is served to the user, and at step 596 processing stops. If the IRE determines that the requested content item is not available at the center node, then at step 554 a message is sent informing the user that the requested content item is not available and at step 593 processing stops.

FIG. 6 provides an overview of exemplary component relationships and information flows which may be used to update user addresses in an embodiment of the present invention.

In an embodiment, a user address database in an IRE (such as IRE 105 of FIG. 1A), comprises a plurality of source blocks, where each source block maps a set of user addresses to a node. The user address database may be updated through BGP information from ISPs participating in the system of the present invention. As shown in FIG. 6, BGP Speaker 621 receives BGP information from BGP Speaker 611 associated with ISP 601, from BGP Speaker 612 associated with ISP 602, and from BGP Speaker 613 associated with ISP 603. In this embodiment, BGP information comprises routing information, including routing policies and protocols for reaching blocks of user addresses. In embodiments, each ISP participating in a redirection system of the present invention supports the same or a similar BGP protocol. In embodiments, BGP information includes information about users, such as the type or quality of link between a user and her ISP. In embodiments, BGP information can include cost information on use of links or routes, which may be used, as described in this specification, in making redirection determinations.

In the embodiment depicted in FIG. 6, BGP Speaker 621 consolidates the information received from BGP 611, BGP 621 and BGP 631, and transmits the consolidated BGP information to ASB 631 in the form of a BGP table. ASB 631 receives BGP information from BGP Speaker 621, and converts that BGP information into source blocks which associate each set of user addresses with an edge node or another node.

As depicted in FIG. 6, ASB 631 also combines the source blocks into source block tables, which it transmits to BRAM 651 (which in this embodiment corresponds to BRAM 305 depicted in FIG. 3). As shown in FIG. 6, in embodiments ASB 631 also transmits alarms and alerts as site-scoped multicasted messages, for example if a source block cannot be created from BGP information, if a source block table cannot be transmitted to BRAM 651, if a source block is deleted, or if other events occur warranting an alert or an alarm. As also depicted in FIG. 6, in embodiments ASB 631 records its transactions, including receipt of BGP information and transmission of source blocks, to Log 691, and to Operator File 641 for inspection and editing by an operator, who can modify both Operator File 641 and corresponding records in BRAM 651. In embodiments, ASB 631 is a single process application, implemented in a combination of hardware and software, that can be run at scheduled times, or as a continuously running process that wakes up at scheduled times and fetches the BGP information from BGP Speaker 621.

In the embodiment depicted in FIG. 6, source block tables are transmitted from ASB 631 to BRAM 651. As depicted in FIG. 6, BRAM 651 also records the source block tables in Database 661. BRAM 631 also transmits the source block tables to IRE 681, which uses the source block tables to make redirection determinations, as described above. Thus, in embodiments of the present invention, source block tables used for redirection determinations can be updated automatically and in near real time as changes are made for example in users, user addresses, server and server locations, and transmission paths between users and servers.

FIG. 7 provides an overview of exemplary component relationships and information flows for updating content item and server information in an embodiment of the present invention. As depicted in FIG. 7, EDM 707 manages and provides content disposition information to SPA 705 for a node such as an edge node. In an embodiment, each server at an edge is equipped with an EDM. In another embodiment, each device such as a disk drive storing content items at a node is equipped with an EDM. In the embodiment depicted in FIG. 7, EDM 707 provides content disposition information for a server, such as information on the availability of content items at the server and the size of the content item file. For example, when a content item is successfully positioned at the server associated with EDM 707, EDM 707 also sends a message to SPA 705 indicating that the content item has been successfully delivered. In embodiments, EDM 707 also sends alerts and alarms to SPA 705. In embodiments, there is a persistent connection between EDM 707 and SPA 705.

In the embodiment depicted in FIG. 7, Smart Probe 709 provides information to SPA 705 concerning the status, health and load of a server in a node, for example, the same server associated with EDM 707. In embodiments, this information includes alerts and alarms, which are sent to SPA 705 via site-scoped multicasting. In embodiments, Smart Probe 709 sends a heartbeat signal to SPA 705: failure to receive the heartbeat signal at the predetermined interval indicates failure or serious malfunction of the server associated with Smart Probe 709. Smart Probe 709 may be an application program that resides on its own system; in other embodiments, Smart Probe 709 may be an application program that resides on a server at a node. In an embodiment, at least one SPA is located at each node, including each edge node. In embodiments, SPA 705 is a multi-threaded Java process that provides both core functionality, such as the ability to add plugins or other application programs to monitor the availability, load and status of various metrics for the server, and to provide statistics and other information concerning server performance, and the ability to launch scripts or other executable programs on command or in response to alerts, alarms, server load levels and other metrics and events.

In the embodiment depicted in FIG. 7, SPA 705 sends information from EDM 707 and Smart Probe 709 to BRAM 703. This includes content disposition information received from EDM 707 and server status, health and load information from Smart Probe 709. In embodiments, SPA 705 transmits information to BRAM 703 when there is a change in the information received by SPA 705 from EDM 707 or Smart Probe 709. In embodiments, SPA 705 sends alerts and alarms via site-scoped multicasting so that a number of system components may become aware of the event triggering the alert or alarm. In an embodiment, SPA 705 may also field alerts and alarms from other elements, components or applications at a node, and transmit those alerts and alarms to BRAM 703.

In an embodiment, SPA 705 maintains an open TCP connection, which may be tunneled through a Virtual Private Network, to BRAM 703. SPA 705 may be configured to send a heartbeat signal to BRAM 703, so that failure of BRAM 703 to receive the signal within a predetermined period would indicate a failure or serious malfunction of SPA 705 or the node at which it resides. In embodiments including a number of servers, each having an SPA, a BRAM is provided with essentially real-time information concerning the disposition of content items as well as the status, health and load of each server having a SPA. In other embodiments (not depicted), a SPA or other component may communicate messages with a BRAM without processing or evaluating the content of the message, thus utilizing a BRAM, SPA or other component as a functionally passive switch or conduit for messages between system components.

As depicted in FIG. 7, in embodiments BRAM 703 also communicates to BMS 701 the content disposition and load, status and health of the server associated with SPA 705. BRAM 703 may also receive initial or run-time configuration information such as the IP addresses of the servers at the node, the types of content served by those servers, the port from which the content is served, heartbeat interval and server load or headroom thresholds. In other embodiments (not depicted), BRAM 703 may also communicate this information to other components, functions and services of a redirection system of the present invention, such as one or more IREs.

In another embodiment (not depicted in FIG. 7), BRAM 703 also communicates messages, including for example status requests and headroom reconfiguration instructions, to SPA 705 and to EDM 707 and Smart Probe 709 through SPA 705. For example, a BMS may determine, as a result of traffic analysis for example, that the headroom of one of the servers at a node should be increased. In an embodiment, the BMS could send a message to that effect to BRAM 703, which would transmit the message to a SPA of the appropriate node, which could also direct execution of the headroom change for the designated server.

In the embodiment as depicted in FIG. 7, BRAM 703 may be implemented as a multi-protocol, mutli-threaded system that acts as a message switch for components and parts of a redirection system of the present invention. BRAM 703 may also maintain a database of information concerning the configuration of the redirection system; source block tables; the location and status of content items; IRE, SPA and other component configuration information; and other information necessary or useful for the operation of the redirection system.

FIG. 8 depicts exemplary component relationships and information flows that could be set up between a SPA, an EDM, a set of smart probes and a set of servers in an embodiment of a system of the present invention including a smart switch. In the embodiment depicted in FIG. 8, SPA 801 is in communication with each of Smart Probes 803, 813 and 823 and with EDM 805 of Node 800. Smart Probe 803 is in communication with Server 833, Smart Probe 813 is in communication with Server 843 and Smart Probe 823 is in communication with Server 853. These smart probes function similarly to Smart Probe 709, and EDM 805 functions similarly to EDM 707, both as described above with reference to FIG. 7. In the embodiment depicted in FIG. 8, however, SPA 801 is also in communication with Smart Switch 809.

As described above, in embodiments of systems and methods of the present invention without a smart switch, an IRE redirects a user access request to a particular server. In other embodiments, as reflected in FIG. 8, an IRE can redirect a user access request to a component—a smart switch—at an edge or other node, which determines which server at that node is “best” according to predetermined criteria, such as the availability or load of the servers at the node with the requested content item.

In an embodiment, each server at an edge or other node is associated with a smart switch that has a list of the servers at the edge. Accordingly, in the embodiment depicted in FIG. 8, each of Server 833, Server 843 and Server 853 is associated with Smart Switch 809. User access requests redirected to Node 800 are initially handled by Smart Switch 809, which routes incoming redirected user access requests to Server 833, Server 843 or Server 853 in round robin fashion. Other methods for distributing user access requests, for example based on the load of Servers 833, 843 and 853 (as reported by Smart Probes 803, 813 and 823, respectively, through SPA 801 to Smart Switch 809 ) at the time of each access request, are apparent in light of this specification and the appended claims. If SPA 801 or EDM 805 reports that one of these servers is not available, then Smart Switch 809 does not pass user access requests to that server.

In an embodiment, each of Servers 833, 843 and 853 stores and can serve the same set of content items. In another embodiment, Servers 833, 843 and 853 store and serve different sets of content items. In such an embodiment, SPA 801 transmits, to a database in Smart Switch 809 or other location accessible to Smart Switch 809, the set of content items stored by each of Servers 833, 843 and 853. If, for example, a user access request specifies a content item not stored or otherwise unavailable at the time of the request from Server 843, then Smart Switch 809 would exclude Server 843 from the servers available to respond to the request.

It will be apparent to those skilled in the art that various modifications can be made to the present invention without departing from the spirit or scope of the invention or of the claims. It is also intended that the present invention and the appended claims cover modifications, variations and equivalents of the method and system of the present invention.

What is claimed is:

1. An article of manufacture comprising a transmitter for transmitting a plurality of signals to a processor using a first network,
wherein the plurality of signals encode a user access request comprising a specification of a content item of a plurality of content items and a user address, associated with a user, of a plurality of user addresses;
wherein program logic configures the processor to
receive the user access request; and
determine, responsive to the specification of the content item and the user address, a service point of a plurality of service points;
wherein a user address database relates the plurality of user addresses to the plurality of service points, and a content item database relates the plurality of service points to the plurality of content items; and
wherein each of the plurality of content items is distributed, prior to receipt by the processor of the user access request, to at least one of the plurality of service points using a second network substantially separate from the first network.

2. The article of manufacture of claim 1, wherein the first network comprises the Internet.

3. The article of manufacture of claim 1, wherein the second network comprises a satellite telecommunications system.

4. The article of manufacture of claim 1, wherein a service point comprises a server.

5. The article of manufacture of claim 4, wherein the user is redirected to the service point.

6. The article of manufacture of claim 5, wherein the user is redirected to the service point responsive to server load information associated with a server at the service point.

7. The article of manufacture of claim 6 wherein the server load information is responsive to content stream quantity of the server.

8. The article of manufacture of claim 7, wherein the server load information is further responsive to content stream delivery rate of each of the streams included in the content stream quantity of the server.

9. The article of manufacture of claim 7 or 8, wherein the server load information is further responsive to headroom of the server.

10. The article of manufacture of claim 6, 7 or 8, wherein the server load information is not responsive to any of the group consisting of CPU load and memory usage of the server.

11. The article of manufacture of claim 1, wherein a service point comprises a service.

12. The article of manufacture of claim 11, wherein the user is redirected to the service.

13. The article of manufacture of claim 11, wherein the service delivers the content item.

14. The article of manufacture of claim 1, wherein the user address database is responsive to a plurality of source blocks.

15. The article of manufacture of claim 1, wherein each of the plurality of service points is assigned to one of a plurality of layers.

16. The article of manufacture of claim 15, wherein the plurality of layers is arranged hierarchically from a highest layer to a lowest layer.

17. The article of manufacture of claim 16, wherein each of the plurality of service points is one of the group consisting of a center node, a regional node, and an edge node.

18. The article of manufacture of claim 17, wherein the plurality of service points comprises a first service point designated as an edge node, a second service point designated as a regional node, and a third service point designated as a center node.

19. The article of manufacture of claim 18, wherein the edge node, the regional node, and the center node are arranged hierarchically.

20. The article of manufacture of claim 19, wherein the center node is assigned to the highest layer, the regional node is assigned to an intermediate layer, and the edge node is assigned to the lowest layer.

21. The article of manufacture of claim 16, wherein the user is redirected to the service point responsive to the hierarchically arranged plurality of layers.

22. The article of manufacture of claim 17, 18, 19, 20 or 21, wherein the user is redirected to the service point responsive to:
a determination, responsive to the user address database, of a set of service points associated with the user; and
an identification, responsive to the content item database and the set of service points associated with the user, of the service point assigned to the lowest layer in the hierarchy of layers that contains the content item.

23. The article of manufacture of claim 22, wherein each of the plurality of service points comprises a server.

24. The article of manufacture of claim 23, wherein the user is redirected to a server at the service point.

25. The article of manufacture of claim 24, wherein the server is selected responsive to server load information associated with the server.

26. The article of manufacture of claim 25, wherein the server load information is responsive to content stream quantity of the server.

27. The article of manufacture of claim 26, wherein the server load information is further responsive to content stream delivery rate of each of the streams included in the content stream quantity of the server.

28. The article of manufacture of claim 26 or 27, wherein the server load information is further responsive to the headroom of the server.

29. The article of manufacture of claim 28, wherein the server load information is not responsive any of the group consisting of CPU load and memory usage of the server.

30. The article of manufacture of claim 23, wherein each server comprises at least one service.

31. The article of manufacture of claim 30, wherein the user is redirected to a service associated with the service point.

32. The article of manufacture of claim 30, wherein each of the at least one service delivers at least one content item.

33. The article of manufacture of claim 32, wherein the at least one content item is delivered by at least one service associated with the service point.

34. The article of manufacture of claim 1, wherein the user address database is updated prior to a redirection of the user to the service point.

35. The article of manufacture of claim 1, wherein the content item database is updated prior to a redirection of the user to the service point.

36. The article of manufacture of claim 1, wherein a central messaging and control mechanism receives information concerning at least one of the plurality of content items and transmits an instruction to update the content item database.

37. The article of manufacture of claim 1, wherein a central messaging and control mechanism receives information concerning at least one of the plurality of user addresses and transmits an instruction to update the user address database.

38. The article of manufacture of claim 36 or 37, wherein a smart proxy agent sends the information received by the central messaging and control mechanism.

39. The article of manufacture of claim 38, wherein the smart proxy agent processes the information prior to sending the processed information to the central messaging and control mechanism.

40. The article of manufacture of claim 39, wherein one of the plurality of service points comprises a smart probe and a smart proxy agent.

41. The article of manufacture of claim 40, wherein the smart probe communicates with the smart proxy agent using a site-scoped multicast message.

42. The article of manufacture of claim 34, wherein the user address database is updated responsive to status information related to one of the plurality of service points.

43. The article of manufacture of claim 42, wherein one of the plurality of service points comprises a server.

44. The article of manufacture of claim 43, wherein the status information comprises information regarding the status of the server.

45. The article of manufacture of claim 43, wherein the status information comprises information regarding server load of the server.

46. The article of manufacture of claim 43, wherein the status information comprises information regarding content availability at the server.

47. The article of manufacture of claim 34, wherein the user address database is updated responsive to information for routing transmissions to the user.

48. The article of manufacture of claim 47, wherein the information for routing transmissions to the user is responsive to information on telecommunications transmission costs.

49. The article of manufacture of claim 34, wherein the user address database is updated by a central messaging and control mechanism.

50. The method of claim 49, wherein the central messaging and control mechanism receives information from a service point responsive to a site-scoped multicast message.

51. The article of manufacture of claim 50, wherein the service point comprises a smart probe and a smart proxy agent wherein
the smart probe communicates with the smart proxy agent using a site-scoped multicast message, and
the smart proxy agent communicates with the central messaging and control mechanism.

52. The article of manufacture of claim 1,
wherein the service point comprises a smart switch and a plurality of servers; and
the user is redirected to the smart switch, wherein the smart switch selects one of the plurality of servers for serving the content item.

53. The article of manufacture of claim 1, wherein the user is redirected to a service point responsive to a container file.

54. The article of manufacture of claim 53, wherein the container file is processed at a service point.

55. The article of manufacture of claim 1, wherein the user address database comprises user class information associated with the user, and the user is redirected to the service point responsive to the user class information associated with the user.

56. The article of manufacture of claim 1, wherein the content item database comprises service class information associated with the content item, and the user is redirected to the service point responsive to the service class information associated with the content item.

57. The article of manufacture of claim 56, wherein the user address database comprises user class information associated with the user, and the user is redirected to the service point responsive to the user class information associated with the user.

58. The article of manufacture of claim 1, wherein a special service code is issued to the user.

59. The article of manufacture of claim 58, wherein the special service code is responsive to user profile information associated with the user.

60. The article of manufacture of claim 58, wherein the user access request further specifies the special service code.

61. An article of manufacture comprising a transmitter for transmitting a plurality of signals to a processor using a first network,
wherein the plurality of signals encode a user access request comprising a specification of a content item of a plurality of content items and a user address, associated with a user, of a plurality of user addresses;
wherein program logic configures the processor to
receive the user access request; and
determine, responsive to the specification of the content item and the user address, a service point of a plurality of service points;
wherein a user address database relates the plurality of user addresses to the plurality of service points, and a content item database relates the plurality of service points to the plurality of content items.

62. A system for redirecting computer network users comprising:
means for receiving, using a first network, a user access request from a user, wherein the user access request comprises a specification of a content item of a plurality of content items and a user address of a plurality of user addresses; and
means for redirecting the user, using a first network, to a service point of a plurality of service points, responsive to the specification of the content item and the user address;
wherein a user address database relates the plurality of user addresses to the plurality of service points, and a content item database relates the plurality of service points to the plurality of content items; and
wherein each of the plurality of content items is distributed, prior to receipt by the receiving means of the user access request, to at least one of the plurality of service points using a second network substantially separate from the first network.

63. The system of claim 62, wherein the first network comprises the Internet.

64. The system of claim 1621, wherein the second network comprises a satellite telecommunications system.

65. The system of claim 62, wherein a service point comprises a server.

66. The system of claim 65, wherein the user is redirected to the service point.

67. The system of claim 66, wherein the user is redirected to the service point responsive to server load information associated with a server at the service point.

68. The system of claim 67 wherein the server load information is responsive to content stream quantity of the server.

69. The system of claim 68, wherein the server load information is further responsive to content stream delivery rate of each of the streams included in the content stream quantity of the server.

70. The system of claim 68 or 69, wherein the server load information is further responsive to headroom of the server.

71. The system of claim 67, 68 or 69, wherein the server load information is not responsive to any of the group consisting of CPU load and memory usage of the server.

72. The system of claim 62, wherein a service point comprises a service.

73. The system of claim 72, wherein the user is redirected to the service.

74. The system of claim 72, wherein the service delivers the content item.

75. The system of claim 67, wherein the user address database is responsive to a plurality of source blocks.

76. The system of claim 62, wherein each of the plurality of service points is assigned to one of a plurality of layers.

77. The system of claim 76, wherein the plurality of layers is arranged hierarchically from a highest layer to a lowest layer.

78. The system of claim 77, wherein each of the plurality of service points is one of the group consisting of a center node, a regional node, and an edge node.

79. The system of claim 78, wherein the plurality of service points comprises a first service point designated as an edge node, a second service point designated as a regional node, and a third service point designated as a center node.

80. The system of claim 79, wherein the edge node, the regional node, and the center node are arranged hierarchically.

81. The system of claim 80, wherein the center node is assigned to the highest layer, the regional node is assigned to an intermediate layer, and the edge node is assigned to the lowest layer.

82. The system of claim 77, wherein the user is redirected to the service point responsive to the hierarchically arranged plurality of layers.

83. The system of claim 78, 79, 80, 81 or 82, wherein the user is redirected to the service point responsive to:
a determination, responsive to the user address database, of a set of service points associated with the user; and
an identification, responsive to the content item database and the set of service points associated with the user, the service point assigned to the lowest layer in the hierarchy of layers that contains the content item.

84. The system of claim 83, wherein each of the plurality of service points comprises a server.

85. The system of claim 84, wherein the user is redirected to a server at the service point.

86. The system of claim 85, wherein the server is selected responsive to server load information associated with the server.

87. The system of claim 86, wherein the server load information is responsive to content stream quantity of the server.

88. The system of claim 87, wherein the server load information is further responsive to content stream delivery rate of each of the streams included in the content stream quantity of the server.

89. The system of claim 87 or 88, wherein the server load information is further responsive to the headroom of the server.

90. The system of claim 89, wherein the server load information is not responsive any of the group consisting of CPU load and memory usage of the server.

91. The system of claim 84, wherein each server comprises at least one service.

92. The system of claim 91, wherein the user is redirected to a service associated with the service point.

93. The system of claim 91, wherein each of the at least one service delivers at least one content item.

94. The system of claim 93, wherein the at least one content item is delivered by at least one service associated with the service point.

95. The system of claim 99, wherein the user address database is updated prior to a redirection of the user to the service point.

96. The system of claim 62, wherein the content item database is updated prior to a redirection of the user to the service point.

97. The system of claim 62, wherein a central messaging and control mechanism receives information concerning at least one of the plurality of content items and transmits an instruction to update the content item database.

98. The system of claim 62, wherein a central messaging and control mechanism receives information concerning at least one of the plurality of user addresses and transmits an instruction to update the user address database.

99. The system of claim 97 or 98, wherein a smart proxy agent sends the information received by the central messaging and control mechanism.

100. The system of claim 99, wherein the smart proxy agent processes the information prior to sending the processed information to the central messaging and control mechanism.

101. The system of claim 100, wherein one of the plurality of service points comprises a smart probe and a smart proxy agent.

102. The system of claim 101, wherein the smart probe communicates with the smart proxy agent using a site-scoped multicast message.

103. The system of claim 95, wherein the user address database is updated responsive to status information related to one of the plurality of service points.

104. The system of claim 103, wherein one of the plurality of service points comprises a server.

105. The system of claim 104, wherein the status information comprises information regarding the status of the server.

106. The system of claim 104, wherein the status information comprises information regarding server load of the server.

107. The system of claim 104, wherein the status information comprises information regarding content availability at the server.

108. The system of claim 95, wherein the user address database is updated responsive to information for routing transmissions to the user.

109. The system of claim 108, wherein the information for routing transmissions to the user is responsive to information on telecommunications transmission costs.

110. The system of claim 95, wherein the user address database is updated by a central messaging and control mechanism.

111. The method of claim 110, wherein the central messaging and control mechanism receives information from a service point responsive to a site-scoped multicast message.

112. The system of claim 113, wherein the service point comprises a smart probe and a smart proxy agent wherein
the smart probe communicates with the smart proxy agent using a site-scoped multicast message, and
the smart proxy agent communicates with the central messaging and control mechanism.

113. The system of claim 62,
wherein the service point comprises a smart switch and a plurality of servers; and
the user is redirected to the smart switch, wherein the smart switch selects one of the plurality of servers for serving the content item.

114. The system of claim 62, wherein the user is redirected to a service point responsive to a container file.

115. The system of claim 114, wherein the container file is processed at a service point.

116. The system of claim 62, wherein the user address database comprises user class information associated with the user, and the user is redirected to the service point responsive to the user class information associated with the user.

117. The system of claim 62, wherein the content item database comprises service class information associated with the content item, and the user is redirected to the service point responsive to the service class information associated with the content item.

118. The system of claim 117, wherein the user address database comprises user class information associated with the user, and the user is redirected to the service point responsive to the user class information associated with the user.

119. The system of claim 62, wherein a special service code is issued to the user.

120. The system of claim 119, wherein the special service code is responsive to user profile information associated with the user.

121. The system of claim 119, wherein the user access request further specifies the special service code.

122. A processor comprising program logic configuring the processor to
receive, via a first network, a user access request generated by a user, the user access request comprising a specification of a content item of a plurality of content items and a user address, associated with the user, of a plurality of user addresses; and
determine, responsive to the specification of the content item and the user address, a service point of a plurality of service points;
wherein a user address database relates the plurality of user addresses to the plurality of service points, and a content item database relates the plurality of service points to the plurality of content items; and
wherein each of the plurality of content items is distributed, prior to receipt by the processor of the user access request, to at least one of the plurality of service points using a second network substantially separate from the first network.

123. The processor of claim 122, wherein the first network comprises the Internet.

124. The processor of claim 122, wherein the second network comprises a satellite telecommunications system.

125. The processor of claim 122, wherein a service point comprises a server.

126. The processor of claim 125, wherein the user is redirected to the service point.

127. The processor of claim 126, wherein the user is redirected to the service point responsive to server load information associated with a server at the service point.

128. The processor of claim 127 wherein the server load information is responsive to content stream quantity of the server.

129. The processor of claim 128, wherein the server load information is further responsive to content stream delivery rate of each of the streams included in the content stream quantity of the server.

130. The processor of claim 128 or 129, wherein the server load information is further responsive to headroom of the server.

131. The processor of claim 127, 128 or 129, wherein the server load information is not responsive to any of the group consisting of CPU load and memory usage of the server.

132. The processor of claim 122, wherein a service point comprises a service.

133. The processor of claim 132, wherein the user is redirected to the service.

134. The processor of claim 132, wherein the service delivers the content item.

135. The processor of claim 122, wherein the user address database is responsive to a plurality of source blocks.

136. The processor of claim 122, wherein each of the plurality of service points is assigned to one of a plurality of layers.

137. The processor of claim 136, wherein the plurality of layers is arranged hierarchically from a highest layer to a lowest layer.

138. The processor of claim 137, wherein each of the plurality of service points is one of the group consisting of a center node, a regional node, and an edge node.

139. The processor of claim 138, wherein the plurality of service points comprises a first service point designated as an edge node, a second service point designated as a regional node, and a third service point designated as a center node.

140. The processor of claim 139, wherein the edge node, the regional node, and the center node are arranged hierarchically.

141. The processor of claim 140, wherein the center node is assigned to the highest layer, the regional node is assigned to an intermediate layer, and the edge node is assigned to the lowest layer.

142. The processor of claim 137, wherein the user is redirected to the service point responsive to the hierarchically arranged plurality of layers.

143. The processor of claim 138, 139, 140, 141 or 142, wherein the user is redirected to the service point responsive to:
a determination, responsive to the user address database, of a set of service points associated with the user; and
an identification, responsive to the content item database and the set of service points associated with the user, of the service point assigned to the lowest layer in the hierarchy of layers that contains the content item.

144. The processor of claim 143, wherein each of the plurality of service points comprises a server.

145. The processor of claim 144, wherein the user is redirected to a server at one of the plurality of service points.

146. The processor of claim 145, wherein the server is selected responsive to server load information associated with the server.

147. The processor of claim 146, wherein the server load information is responsive to content stream quantity of the server.

148. The processor of claim 147, wherein the server load information is further responsive to content stream delivery rate of each of the streams included in the content stream quantity of the server.

149. The processor of claim 147 or 148, wherein the server load information is further responsive to the headroom of the server.

150. The processor of claim 149, wherein the server load information is not responsive any of the group consisting of CPU load and memory usage of the server.

151. The processor of claim 144, wherein each server comprises at least one service.

152. The processor of claim 151, wherein the user is redirected to a service associated with the service point.

153. The processor of claim 151, wherein each of the at least one service delivers at least one content item.

154. The processor of claim 153, wherein the at least one content item is delivered by at least one service associated with the service point.

155. The processor of claim 122, wherein the user address database is updated prior to a redirection of the user to the service point.

156. The processor of claim 122, wherein the content item database is updated prior to a redirection of the user to the service point.

157. The processor of claim 122, wherein a central messaging and control mechanism receives information concerning at least one of the plurality of content items and transmits an instruction to update the content item database.

158. The processor of claim 122, wherein a central messaging and control mechanism receives information concerning at least one of the plurality of user addresses and transmits an instruction to update the user address database.

159. The processor of claim 157 or 158, wherein a smart proxy agent sends the information received by the central messaging and control mechanism.

160. The processor of claim 159, wherein the smart proxy agent processes the information prior to sending the processed information to the central messaging and control mechanism.

161. The processor of claim 160, wherein one of the plurality of service points comprises a smart probe and a smart proxy agent.

162. The processor of claim 160, wherein the smart probe communicates with the smart proxy agent using a site-scoped multicast message.

163. The processor of claim 155, wherein the user address database is updated responsive to status information related to one of the plurality of service points.

164. The processor of claim 163, wherein one of the plurality of service points comprises a server.

165. The processor of claim 164, wherein the status information comprises information regarding the status of the server.

166. The processor of claim 164, wherein the status information comprises information regarding server load of the server.

167. The processor of claim 164, wherein the status information comprises information regarding content availability at the server.

168. The processor of claim 155, wherein the user address database is updated responsive to information for routing transmissions to the user.

169. The processor of claim 168, wherein the information for routing transmissions to the user is responsive to information on telecommunications transmission costs.

170. The processor of claim 155, wherein the user address database is updated by a central messaging and control mechanism.

171. The method of claim 170, wherein the central messaging and control mechanism receives information from a service point responsive to a site-scoped multicast message.

172. The processor of claim 171, wherein the service point comprises a smart probe and a smart proxy agent wherein
the smart probe communicates with the smart proxy agent using a site-scoped multicast message, and
the smart proxy agent communicates with the central messaging and control mechanism.

173. The processor of claim 122,
wherein the service point comprises a smart switch and a plurality of servers; and
the user is redirected to the smart switch, wherein the smart switch selects one of the plurality of servers for serving the content item.

174. The processor of claim 122, wherein the user is redirected to a service point responsive to a container file.

175. The processor of claim 174, wherein the container file is processed at a service point.

176. The processor of claim 122, wherein the user address database comprises user class information associated with the user, and the user is redirected to the service point responsive to the user class information associated with the user.

177. The processor of claim 122, wherein the content item database comprises service class information associated with the content item, and the user is redirected to the service point responsive to the service class information associated with the content item.

178. The processor of claim 177, wherein the user address database comprises user class information associated with the user, and the user is redirected to the service point responsive to the user class information associated with the user.

179. The processor of claim 122, wherein a special service code is issued to the user.

180. The processor of claim 179, wherein the special service code is responsive to user profile information associated with the user.

181. The processor of claim 179, wherein the user access request further specifies the special service code.

182. A system for redirecting computer network users comprising:
means for receiving, using a first network, a user access request from a user, wherein the user access request comprises a specification of a content item of a plurality of content items and a user address of a plurality of user addresses; and
means for redirecting the user, using a first network, to a service point of a plurality of service points, responsive to the specification of the content item and the user address;
wherein a user address database relates the plurality of user addresses to the plurality of service points, and a content item database relates the plurality of service points to the plurality of content items.

183. A processor comprising program logic configuring the processor to
receive, via a first network, a user access request generated by a user, the user access request comprising a specification of a content item of a plurality of content items and a user address, associated with the user, of a plurality of user addresses; and
determine, responsive to the specification of the content item and the user address, a service point of a plurality of service points;
wherein a user address database relates the plurality of user addresses to the plurality of service points, and a content item database relates the plurality of service points to the plurality of content items.
